(19) United States
(12) Patent Application Publication
(10) Pub. No.: US 2025/0051527 A1
(43) Pub. Date: Feb. 13, 2025

(54) CROSSLINKED, FOAMED OLEFIN/SILANE INTERPOLYMER COMPOSITIONS

(71) Applicant: Dow Global Technologies LLC, Midland, MI (US)

(72) Inventors: Bo Lyu, Shanghai (CN); Xiaochun Liu, Shanghai (CN); Yabin Sun, Shanghai (CN); Wenxin Zhang, Shanghai (CN); Colin Li Pi Shan, Pearland, TX (US); Gaoxiang Wu, Houston, TX (US)

(21) Appl. No.: 18/719,393

(22) PCT Filed: Dec. 17, 2021
(86) PCT No.: PCT/CN2021/138998

§ 371 Date: Jun. 13, 2024

(51) Int. Cl. C08J 3/20; C08J 9/00; C08J 9/10

(52) U.S. Cl. CPC C08J 3/201; C08J 9/0023; C08J 9/0066; C08J 9/0095; C08J 9/103; C08J 2201/026; C08J 2323/24

(57) ABSTRACT

A process to form a crosslinked, foamed composition, and related processes and compositions, the process comprising thermally treating a first composition that comprises the following components: a) at least one olefin/silane interpolymer comprising at least one Si—H group, b) at least one peroxide, and c) at least one blowing agent.

### BACKGROUND OF THE INVENTION

Polymeric crosslinked, foams are widely used in many consumer areas, such as footwear midsole applications. Conventional foam is typically made from compositions containing an olefin-based elastomer, a peroxide, and a blowing agent. Di-cumyl peroxide (DCP) is commonly used as the peroxide for crosslinking; however, currently, industries are turning to costly bis(t-butylperoxyisopropyl)benzene (BIPB) for peroxide crosslinking. BIPB generates less odor in the foam product, as compared to DCP. Acetophenone (AP), a decomposition product from DCP, was identified as the major source of odor in “DCP cured foams” (see Gert Heinrich, Advanced Rubber Composites, Springer, 2011, 227). Acetophenone is not generated in the degradation of BIPB. However, compared to DCP, BIPB has the following disadvantages as a peroxide curing system: a) a major decomposition product of BIPB is a crystal-like solid with higher polarity, which may cause migration problems in non-polar polymers, such as olefin-based polymers, especially at high loading of BIPB, and b) BIPB needs higher curing temperatures and/or extended curing times. Thus, there is a need for foam compositions that can be effectively cured with peroxides such as DCP, without the odor issues associated with such peroxides.

Also, curing is mandatory in many elastomers applications, such as footwear, rubber, and photo-voltaic (PV) applications. The crosslinked structure can significantly reduce the polymer chain mobility under force/pressure, which can improve many performance properties, including, but not limited to, melt strength, compression set, and high temperature resistance. The amount of crosslinking in a foam can be monitored by its gel content (for example, Gel %). When the gel content reaches a certain level (for example, 40%-85%), a homogeneous foam can be obtained. Too low a gel content cannot form a suitable crosslinking structure to prevent gas leakage, and too high a gel content can form a rigid polymer skeleton, which can affect the ability of the foam to expand. There is a need for foam compositions that can be effectively cured to appropriate gel levels for optimal foam expansion and mechanical properties.

U.S. Pat. No. 6,624,254 discloses the syntheses of silane functionalized polymers, and polymer conversions through coupling, hydrolysis, hydrolysis and neutralization, condensation, oxidation and hydrosilation (see abstract). Peroxides may be used for oxidation and condensation reactions (see column 25, lines 41-46, and column 26, lines 27-36). The interpolymers, and derivatives thereof, may be usefully employed in the preparation of solid objects and articles, such as moldings, films, sheets and foamed objects by molding, extruding or the like (see column 1, lines 14-18, and column 33, lines 16-19). See also, U.S. Pat. No. 6,258,902. Silyl-terminated polyolefins and/or silane functionalized polyolefins are disclosed in the following references: U.S. Pat. Nos. 6,075,103; 5,578,690; H. Makio et al., Silanolytic Chain Transfer in Olefin Polymerization with Supported Single-Site Ziegler-Natta Catalysts, Macromolecules, 2001, 34, 4676-4679; S. B. Amin et al., Alkenylsilane Effects on Organotitanium-Catalyzed Ethylene Polymerization Toward Simultaneous Polyolefin Branch and Functional Group Introduction, J. Am. Chem. Soc., 2006, 128, 4506-4507.

U.S. Publication 2019/0225786 discloses a composition comprising polyethylene, a multifunctional coagent, and a free radical generator (see abstract). Such compositions may be used to form modified and crosslinked polyethylene. U.S. Pat. No. 10,308,829 discloses polymeric compositions comprising a polyolefin having hydrolyzable silane groups, an organic peroxide, and optionally, a catalyst (see abstract) to catalyze hydrolyzation and condensation. A second step crosslinking was observed in the presence of a silanol condensation catalyst (for example, a sulfonic acid or a blocked sulfonic acid) to further link the hydrolysable silane groups in the polymer chain, to generate enhanced crosslinking efficiency. Hydrolyzable silane groups include alkoxy groups, aryloxy groups, aliphatic acyloxy groups, amino or substituted amino groups, and lower alkyl groups (see, for example, column 4, lines 30-49).

U.S. Pat. No. 5,741,858 discloses a silane-crosslinked blend comprising the following: a) a polyolefin elastomer with a density less than 0.885 g/cc, b) a crystalline polyolefin, and c) a silane crosslinker (see claim 1). Suitable silanes contain hydrolyzable groups, such as alkoxy groups, aryloxy groups, aliphatic acyloxy groups, amino or substituted amino groups, and lower alkyl groups (see, for example, column 1, lines 44-60). The silane is typically grafted onto the elastomer backbone, thus requiring an additional processing step, prior to crosslinking. The crosslinking of the silane grafted polymers is promoted with a catalyst.

However, as discussed, there remains a need for foam compositions that can be effectively cured with peroxides such as DCP, without the odor issues associated with such peroxides. Further there remains a need for foam compositions that can be effectively cured to appropriate gel levels for optimal foam expansion and mechanical properties. These needs have been met by the following invention.

### SUMMARY OF THE INVENTION

In a first aspect, a process to form a crosslinked, foamed composition, the process comprising thermally treating a first composition that comprises the following components:
a) at least one olefin/silane interpolymer comprising at least one Si—H group,
b) at least one peroxide, and
c) at least one blowing agent.

In a second aspect, a process to reduce the acetophenone residual ratio (APRR) in a crosslinked, foamed composition formed from a first composition, the process comprising thermally treating the first composition, and wherein the first composition comprises the following components:
a) at least one olefin/silane interpolymer comprising at least one Si—H group,
b) at least one peroxide, and
c) at least one blowing agent.

In a third aspect, a first composition comprising the following components:
a) at least one olefin/silane interpolymer comprising at least one Si—H group,
b) at least one peroxide, and
c) at least one blowing agent.

### DETAILED DESCRIPTION OF THE INVENTION

Crosslinked, foamed compositions have been discovered that have reduced odor in the foamed form, and have the appropriate amount of crosslinking for optimal foam expansion (homogeneous foam) and mechanical properties. The compositions can effectively reduce odor associated with DCP degradation. It is hypothesized that the silane (SiH) groups in the inventive compositions react with acetophenone under conditions used to promote peroxide cure. Below, in Scheme A, is a proposed mechanism of the reaction of the silane with acetophenone under a radical curing process (see also, M. Kidonakis, J. Org. Chem. 2018, 83, 15553-15557). In this reaction, free acetophenone concentration is significantly reduced, and thus the total VOC content is also reduced.

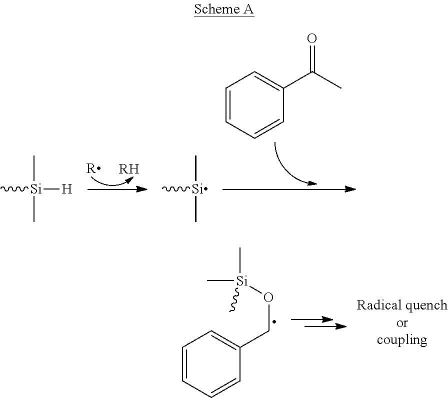

As discussed, in a first aspect, a process to form a crosslinked, foamed composition, the process comprising thermally treating a first composition as described above. In a second aspect, a process to reduce the acetophenone residual ratio (APRR) in a crosslinked, foamed composition, formed from a first composition as described above. In a third aspect, a first composition comprising the following components a, b and c as described above.

Each process may comprise a combination of two or more embodiments, as described herein Each composition may comprise a combination of two or more embodiments, as described herein. Each component a, b and c may comprise a combination of two or more embodiments, as described herein. The following embodiments apply to the first through third aspects of the invention, unless stated otherwise.

In one embodiment, or a combination of two or more embodiments, each described herein, the crosslinked, foam composition (C) has a reduced acetophenone residual ratio (APRR), as compared to a similar composition (SC) that comprises the same components, except that olefin/silane interpolymer of component a is replaced with a similar olefin-based polymer that contains the same monomer types as the interpolymer of component a, except the olefin-based polymer does not contain the “at least one Si—H group,” and wherein the similar olefin-based polymer has a density that is within ±0.005 g/cc of the density of component a, and has a melt index (I2) that is within ±0.5 g/10 min of the melt index of component a; and wherein the Reduction in APRR (%)={[(APRR for (SC))−(APRR for (C))]/(APRR for (SC))}×100.

In one embodiment, or a combination of two or more embodiments, each described herein, the crosslinked, foamed composition has an acetophenone residual ratio (APRR)≤12%, or ≤11%, or ≤10%, or ≤9.0%, or ≤8.0%, or ≤7.0%, or ≤6.0%.

In one embodiment, or a combination of two or more embodiments, each described herein, the crosslinked, foamed composition has a gel content (Gel %) ≥30 wt %, or ≥35 wt %, or ≥40 wt %, or ≥45 wt %, or ≥50 wt %, or ≥55 wt %, or ≥60 wt %, or ≥65 wt %, or ≥70 wt %, or ≥72 wt %, or ≥74 wt %, or ≥76 wt %. In one embodiment, or a combination of two or more embodiments, each described herein, the crosslinked, foamed composition has a gel content (Gel %) ≤85 wt %, or ≤84 wt %, or ≤83 wt %, or ≤82 wt %, or ≤81 wt %.

In one embodiment, or a combination of two or more embodiments, each described herein, component b is selected from Formula P:

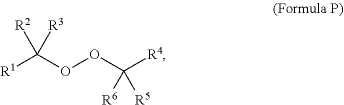

where R1 is a substituted or unsubstituted aryl group; R4 is a substituted or unsubstituted aryl group; R2, R3, R5 and R6 are each, independently, alkyl or H, or C1-C5 alkyl or H, or methyl or H.

In one embodiment, or a combination of two or more embodiments, each described herein, for Formula P, R1 is an unsubstituted aryl group, and further phenyl; and R4 is an unsubstituted aryl group, and further phenyl.

In one embodiment, or a combination of two or more embodiments, each described herein, Formula P is di-cumylperoxide.

In one embodiment, or a combination of two or more embodiments, each described herein, component c is selected from inorganic blowing agents, organic blowing agents, and combinations thereof, and further from organic blowing agents. In one embodiment, or a combination of two or more embodiments, each described herein, component c is selected from azodicarbonamide, azodicarbonamide modified with metal oxide or metal salt, benzenesulfonyl hydrazide, dinitrosopentamethylenetetramine, sodium bicarbonate, ammonium carbonate, water, nitrogen gas, or carbon dioxide gas.

In one embodiment, or a combination of two or more embodiments, each described herein, the olefin/silane interpolymer of component a is an ethylene/silane interpolymer, or an ethylene/alpha-olefin/silane interpolymer, or an ethylene/alpha-olefin/silane terpolymer. In one embodiment, or a combination of two or more embodiments, each described herein, the alpha-olefin of the ethylene/alpha-olefin/silane interpolymer or terpolymer is a C3-C20 alpha-olefin, or a C3-C10 alpha-olefin, or a C3-C8 alpha-olefin, or one of propylene, 1-butene, 1-hexene or 1-octene, or one of propylene, 1-butene, or 1-octene, or one of 1-butene or 1-octene, or 1-octene.

In one embodiment, or a combination of two or more embodiments, each described herein, the olefin/silane interpolymer of component a has a density ≥0.855 g/cc, or ≥0.856 g/cc, or ≥0.857 g/cc, or ≥0.858 g/cc, or ≥0.859 g/cc, or ≥0.860 g/cc, or ≥0.861 g/cc, or ≥0.862 g/cc, or ≥0.863 g/cc, or ≥0.864 g/cc, or ≥0.865 g/cc, or ≥0.866 g/cc, or ≥0.867 g/cc, or ≥0.868 g/cc, or ≥0.869 g/cc, or ≥0.870 g/cc (1 cc=1 cm³). In one embodiment, or a combination of two or more embodiments, each described herein, the olefin/silane interpolymer of component a has a density ≤0.940 g/cc, or ≤0.930 g/cc, or ≤0.920 g/cc, or ≤0.910 g/cc, or ≤0.900 g/cc, or ≤0.890 g/cc, or ≤0.888 g/cc, or ≤0.886 g/cc, or ≤0.884 g/cc, or ≤0.882 g/cc, or ≤0.881 g/cc, or ≤0.880 g/cc, or ≤0.879 g/cc.

In one embodiment, or a combination of two or more embodiments, each described herein, the olefin/silane interpolymer of component a has a melt index (I2) ≥0.2 g/10 min, or ≥0.5 g/10 min, or ≥0.6 g/10 min, or ≥0.7 g/10 min, or ≥0.8 g/10 min. In one embodiment, or a combination of two or more embodiments, each described herein, the olefin/silane interpolymer of component a has a melt index (I2) ≤100 g/10 min, or ≤50 g/10 min, or ≤20 g/10 min, or ≤18 g/10 min, or ≤16 g/10 min, or ≤14 g/10 min, or ≤12 g/10 min, or ≤10 g/10 min, or ≤8.0 g/10 min, or ≤6.0 g/10 min, or ≤4.0 g/10 min, or ≤2.0 g/10 min, or ≤1.0 g/10 min.

In one embodiment, or a combination of two or more embodiments, each described herein, the weight ratio of component a to component b is amount ≥150, or ≥170, or ≥200, or ≥210, or ≥220, or ≥230, or ≥235, or ≥240, or ≥245, and/or ≤400, or ≤370, or ≤350, or ≤345, or ≤340, or ≤338, or ≤335.

In one embodiment, or a combination of two or more embodiments, each described herein, the first composition is thermally treated at a temperature ≥150° C., or ≥155° C., or ≥160° C., or ≥165° C., or ≥170° C., or ≥175° C. In one embodiment, or a combination of two or more embodiments, each described herein, the first composition is thermally treated at a temperature ≤200° C., or ≤195° C., or ≤190° C., or ≤185° C., or ≤180° C.

Also provided is a crosslinked, foam composition formed by the process of any one embodiment, or a combination of two or more embodiments, each described herein.

Also provided is a crosslinked, foam composition formed from the first composition of any one embodiment, or a combination of two or more embodiments, each described herein. Further, the crosslinked, foamed composition is formed by thermally treating the first composition of any one embodiment, or a combination of two or more embodiments, each described herein.

Also provided is an article comprising at least one component formed from the first composition of any one embodiment, or a combination of two or more embodiments, each described herein.

Also provided is an article comprising at least one component formed from the crosslinked, foamed composition of any one embodiment, or a combination of two or more embodiments, each described herein.

### Blowing Agents

A blowing agent (or foaming agent) is a material (for example, a compound or mixture of compounds) that facilitates the formation of a foam; for example, by trapping air or gas inside a solid forming polymer composition, by generating gas after thermal degradation, or by diffusing into polymers under high pressure. Blowing agents suitable for making the foams disclosed herein can include, but are not limited to, inorganic blowing agents, organic blowing agents, and combinations thereof. Some blowing agents are disclosed in Sendijarevic et al., “Polymeric Foams and Foam Technology. Hanser Gardner Publications, Cincinnati, Ohio, 2nd edition, Chapter 18, pages 505-547 (2004), which is incorporated herein by reference. Non-limiting examples of suitable inorganic blowing agents include carbon dioxide, nitrogen, argon, water, air, and helium. Non-limiting examples of suitable organic blowing agents include aliphatic hydrocarbons having, for example, 1-6 carbon atoms, aliphatic alcohols having, for example, 1-3 carbon atoms, and fully and partially halogenated aliphatic hydrocarbons having, for example, 1-4 carbon atoms. Non-limiting examples of suitable aliphatic hydrocarbons include methane, ethane, propane, n-butane, isobutane, n-pentane, isopentane, neopentane, and the like. Non-limiting examples of suitable aliphatic alcohols include methanol, ethanol, n-propanol, and isopropanol. Non-limiting examples of suitable, fully and partially halogenated aliphatic hydrocarbons include fluorocarbons, chlorocarbons, and chlorofluorocarbons.

Non-limiting examples of suitable fluorocarbons include methyl fluoride, perfluoromethane, ethyl fluoride, 1,1-difluoroethane (HFC-152a), 1,1,1-trifluoroethane (HFC-143a), 1,1,1,2-tetrafluoroethane (HFC-134a), pentafluoroethane, difluoromethane, perfluoroethane, 2,2-difluoropropane, 1,1,1-trifluoropropane, perfluoropropane, dichloropropane, difluoropropane, perfluorobutane, perfluorocyclobutane. Non-limiting examples of suitable, partially halogenated chlorocarbons and chlorofluorocarbons include methyl chloride, methylenechloride, ethyl chloride, 1,1,1-trichloroethane, 1,1-dichloro-1-fluoroethane (HCFC-141b), 1-chloro-1, 1 difluoroethane (HCFC-142b), 1,1-dichloro-2,2,2-trifluoroethane (HCFC-123) and 1-chloro-1,2,2,2-tetra-fluoroethane (HCFC-124). Non-limiting examples of suitable, fully halogenated chloro-fluorocarbons include trichloromonofluoromethane (CFC11), dichlorodifluoro-methane (CFC-12), trichlorotrifluoroethane (CFC-113), 1,1,1-trifluoroethane, pentafluoroethane, dichlorotetrafluoroethane (CFC-114), chloroheptafluoropropane, and dichlorohexa-fluoropropane.

Non-limiting examples of suitable organic blowing agents include azodicarbonamide, azodiisobutyronitrile, benzenesulfonhydrazide, 4,4-oxybenzene sulfonyl-semicarbazide, p-toluenesulfonyl semi-carbazide, barium azodicarboxylate, N,N′-dimethyl-N,N′-dinitrosoterephthalamide, and trihydrazinotriazine. As an example, the blowing agent could be selected from azodicarbonamide, modified azodicarbonamide, benzenesulfonyl hydrazide, dinitrosopentamethylenetetramine, sodium bicarbonate, ammonium carbonate, nitrogen gas, and carbon dioxide gas.

### Peroxides

As used herein, a peroxide contains at least one oxygen-oxygen bond (O—O). Peroxides include, but are not limited to, dialkyl, diaryl, dialkaryl, or diaralkyl peroxide, having the same or differing respective alkyl, aryl, alkaryl, or aralkyl moieties, and further each dialkyl, diaryl, dialkaryl, or diaralkyl peroxide, having the same respective alkyl, aryl, alkaryl, or aralkyl moieties.

Exemplary organic peroxides include dicumyl peroxide (“DCP”); tert-butyl peroxybenzoate; di-tert-amyl peroxide (“DTAP”); bis(t-butyl-peroxy isopropyl) benzene (“BIPB”); isopropylcumyl t-butyl peroxide; t-butylcumylperoxide; di-t-butyl peroxide; 2,5-bis(t-butylperoxy)-2,5-dimethylhexane; 2,5-bis(t-butylperoxy)-2,5-dimethylhexyne-3; 1,1-bis(t-butylperoxy)3,3,5-trimethylcyclohexane; isopropylcumyl cumylperoxide; butyl 4,4-di(tert-butylperoxy)valerate; di(isopropylcumyl) peroxide; 1,1-di-(tert-butylperoxy)-cyclohexane (“LUPEROX 331”); 1,1-di-(tert-amylperoxy)cyclohexane (“LUPEROX 531”); tert-butylperoxyacetate (“TBPA”); tert-amyl peroxyacetate (“TAPA”); 2,5-dimethyl-2,5-di(tert-butylperoxy)hexane (“LUPEROX 101”); tert-butylperoxy-2-ethylhexyl carbonate (“TBEC”); and mixtures of two or more thereof.

The peroxide may be a cyclic peroxide. Examples of cyclic peroxides include those derived from acetone, methylamyl ketone, methylheptyl ketone, methylhexyl ketone, methylpropyl ketone, methylbutyl ketone, diethyl ketone, methylethyl ketone, methyloctyl ketone, methylnonyl ketone, methyldecyl ketone, methylundecyl ketone and combinations thereof, among others. The cyclic peroxides can be used alone or in combination with one another. A number of cyclic peroxides are commercially available, for example, under the tradename TRIGONOX, such as 3,6,9-triethyl-3,6,9-trimethyl-1,4,7-triperoxonane.

### Definitions

Unless stated to the contrary, implicit from the context, or customary in the art, all parts and percents are based on weight, and all test methods are current as of the filing date of this disclosure.

The term “composition,” as used herein, includes a mixture of materials, which comprise the composition, as well as reaction products and decomposition products formed from the materials of the composition. Any reaction product or decomposition product is typically present in trace or residual amounts.

The term “polymer,” as used herein, refers to a polymeric compound prepared by polymerizing monomers, whether of the same or a different type. The generic term polymer thus, includes the term homopolymer (employed to refer to polymers prepared from only one type of monomer, with the understanding that trace amounts of impurities can be incorporated into the polymer structure), and the term interpolymer as defined hereinafter. Trace amounts of impurities, such as catalyst residues, can be incorporated into and/or within the polymer. Typically, a polymer is stabilized with very low amounts (“ppm” amounts) of one or more stabilizers.

The term “interpolymer,” as used herein, refers to polymer prepared by the polymerization of at least two different types of monomers. The term interpolymer thus includes the term copolymer (employed to refer to polymers prepared from two different types of monomers) and polymers prepared from more than two different types of monomers.

The term “olefin-based polymer,” as used herein, refers to a polymer that comprises, in polymerized form, at least 50 wt % or a majority weight percent of an olefin, such as ethylene or propylene (based on the weight of the polymer), and optionally may comprise one or more comonomers.

The term “propylene-based polymer,” as used herein, refers to a polymer that comprises, in polymerized form, a majority weight percent of propylene (based on the weight of the polymer), and optionally may comprise one or more comonomers.

The term “ethylene-based polymer,” as used herein, refers to a polymer that comprises, in polymerized form, at least 50 wt % or a majority weight percent of ethylene (based on the weight of the polymer), and optionally may comprise one or more comonomers.

The term “ethylene/alpha-olefin interpolymer,” as used herein, refers to a random interpolymer that comprises, in polymerized form, at least 50 wt % or a majority weight percent of ethylene (based on the weight of the interpolymer), and an alpha-olefin.

The term, “ethylene/alpha-olefin copolymer,” as used herein, refers to a random copolymer that comprises, in polymerized form, at least 50 wt % or a majority weight percent of ethylene (based on the weight of the copolymer), and an alpha-olefin, as the only two monomer types.

The term “olefin multi-block interpolymer,” as used herein, refers to an interpolymer that is characterized by multiple blocks or segments of two or more polymerized monomer units, differing in chemical or physical properties. In some embodiments, the multi-block interpolymers can be represented by the following formula: (AB)ₙ, where n is at least 1, preferably an integer greater than 1, such as 2, 3, 4, 5, 10, 15, 20, 30, 40, 50, 60, 70, 80, 90, 100, or higher. Here, “A” represents a hard block or segment, and “B” represents a soft block or segment. Preferably the A segments and the B segments are linked in a substantially linear fashion, as opposed to a substantially branched or substantially star-shaped fashion. Preferably, the A segments and the B segments are randomly distributed along the polymer chain. These multi block interpolymers, in general, are produced via a chain shuttling process, such as, for example, described in U.S. Pat. No. 7,858,706, which is herein incorporated by reference. See also U.S. Pat. Nos. 9,243,173; 7,608,668; U.S. Pat. Nos. 7,893,166; 7,947,793; and U.S. Publication 2010/0197880; each patent reference incorporated herein by reference. The interpolymer comprises, in polymerized form, at least 50 wt % or a majority weight percent of an olefin, such as ethylene or propylene (based on the weight of the multi-block interpolymer), and one or more comonomers.

The term “ethylene/alpha-olefin multi-block interpolymer,” as used herein, refers to an interpolymer that is characterized by multiple blocks or segments of two or more polymerized monomer units, differing in chemical or physical properties, as described above for olefin multi-block interpolymer. The ethylene/alpha-olefin multi-block interpolymer comprises, in polymerized form, at least 50 wt % or a majority weight percent of ethylene (based on the weight of the multi-block interpolymer), and an alpha-olefin.

The term “ethylene/alpha-olefin multi-block copolymer,” as used herein, refers to a copolymer that is characterized by multiple blocks or segments of two polymerized monomer units, differing in chemical or physical properties, as described above for olefin multi-block interpolymer. The ethylene/alpha-olefin multi-block copolymer comprises, in polymerized form, at least 50 wt % or a majority weight percent of ethylene (based on the weight of the multi-block copolymer), and an alpha-olefin, as the only two monomer types.

The term “olefin/silane interpolymer,” as used herein, refers to a random interpolymer that comprises, in polymerized form, at least 50 wt % or a majority weight percent of an olefin (based on the weight of the interpolymer), and a silane monomer. As used herein, the interpolymer comprises at least one Si—H group, and the phrase “at least one Si—H group” refers to a type of “Si—H” group. It is understood in the art that the interpolymer would contain a multiple number of these groups. The olefin/silane interpolymer is formed by the copolymerization (for example, using a bis-biphenyloxy metal complex (or bis-biphenyl-phenoxy metal complex)) of at least the olefin and the silane monomer. An example of a silane monomer is depicted in Formula 1, as described above.

The term “ethylene/silane interpolymer,” as used herein, refers to a random interpolymer that comprises, in polymerized form, at least 50 wt % or a majority weight percent of ethylene (based on the weight of the interpolymer), and a silane monomer. As used herein, the interpolymer comprises at least one Si—H group as discussed above. The ethylene/silane interpolymer is formed by the copolymerization of at least the ethylene and the silane monomer.

The term “ethylene/alpha-olefin/silane interpolymer,” as used herein, refers to a random interpolymer that comprises, in polymerized form, at least 50 wt % or a majority weight percent of ethylene (based on the weight of the interpolymer), an alpha-olefin and a silane monomer. As used herein, these interpolymer comprises at least one Si—H group, as discussed above. The ethylene/alpha-olefin/silane interpolymer is formed by the copolymerization of at least the ethylene, the alpha-olefin and the silane monomer.

The term “ethylene/alpha-olefin/silane terpolymer,” as used herein, refers to a random terpolymer that comprises, in polymerized form, at least 50 wt % or a majority weight percent of ethylene (based on the weight of the terpolymer), an alpha-olefin and a silane monomer as the only three monomer types. As used herein, the terpolymer comprises at least one Si—H group, as discussed above. The ethylene/alpha-olefin/silane terpolymer is formed by the copolymerization of the ethylene, the alpha-olefin and the silane monomer, as the only three monomer types.

The phrase “a majority weight percent,” as used herein, in reference to a polymer (or interpolymer, or terpolymer or copolymer), refers to the amount of monomer present in the greatest amount in the polymer.

The term “heteroatom,” refers to an atom other than hydrogen or carbon (for example, O, S, N or P). The term “heteroatom group” refers to a heteroatom or a chemical group containing one or more heteroatoms.

The terms “hydrocarbon,” “hydrocarbyl,” and similar terms, as used herein, refer to a respective compound or chemical group, etc., containing only carbon and hydrogen atoms. A divalent “hydrocarbylene group” is defined in similar manner.

The terms “heterohydrocarbon,” “heterohydrocarbyl,” and similar terms, as used herein, refer to a respective hydrocarbon,” or “hydrocarbyl group, etc., in which at least one carbon atom is substituted with a heteroatom group (for example, O, S, N or P). The monovalent heterohydrocarbyl group may be bonded to the remaining compound of interest via a carbon atom or via a heteroatom. A divalent “heterohydrocarbylene group” is defined in similar manner; and the divalent heterohydrocarbylene group may be bonded to the remaining compound of interest via two carbon atoms, or two heteroatoms, or a carbon atom and a heteroatom.

The terms “substituted hydrocarbon,” “substituted hydrocarbyl group,” and similar terms, as used herein, refer to a respective hydrocarbon or hydrocarbyl group, etc., in which one or more hydrogen atoms is/are independently substituted with a heteroatom group. The terms “substituted heterohydrocarbon,” “substituted heterohydrocarbyl group,” etc., are similarly defined.

The terms “substituted aryl,” “substituted aryl group,” and similar terms, as used herein, refer to an aryl group, etc., in which one or more hydrogen atoms is/are independently substituted with a heteroatom group.

The terms “thermally treating,” “thermal treatment,” and similar terms, as used herein, in reference to a composition comprising an olefin/silane interpolymer, refer to the application of heat to the composition. As an example, heat may be applied by electrical means (for example, a heating coil) and/or by radiation and/or by hot oil and/or by mechanical shearing. Note, the temperature at which the thermal treatment takes place, refers to the temperature of the composition (for example, the melt temperature of the composition).

The term “alkenyl group,” as used herein, refers to an organic chemical group that contains at least one carbon-carbon double bond (C═C). In a preferred embodiment, the alkenyl group is a hydrocarbon group containing at least one carbon-carbon double bond, and further containing only one carbon-carbon double bond.

The terms “comprising,” “including,” “having,” and their derivatives, are not intended to exclude the presence of any additional component, step or procedure, whether the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation, any other component, step or procedure, excepting those that are not essential to operability. The term “consisting of” excludes any component, step or procedure, not specifically delineated or listed.

As used herein, in reference to Formula P, R¹=R1, R²=R2, and so forth.

### Listing of Some Processes and Compositions

A] A process to form a crosslinked, foamed composition, the process comprising thermally treating a first composition that comprises the following components:
a) at least one olefin/silane interpolymer comprising at least one Si—H group,
b) at least one peroxide, and
c) at least one blowing agent. Further, component a comprises one olefin/silane interpolymer comprising at least one Si—H group.
   B] A process to reduce the acetophenone residual ratio (APRR) in a crosslinked, foamed composition formed from a first composition, the process comprising thermally treating the first composition, and wherein the first composition comprises the following components:
a) at least one olefin/silane interpolymer comprising at least one Si—H group,
b) at least one peroxide, and
c) at least one blowing agent. Further, component a comprises one olefin/silane interpolymer comprising at least one Si—H group.
   C] The process of A] or B] above, wherein the crosslinked, foam composition (C) has a reduced acetophenone residual ratio (APRR), as compared to a similar composition (SC) that comprises the same components, except that the olefin/silane interpolymer of component a is replaced with a similar olefin-based polymer that contains the same monomer types as the interpolymer of component a, except the olefin-based polymer does not contain the “at least one Si—H group,” and wherein the similar olefin-based polymer has a density that is within ±0.005 g/cc of the density of component a, and has a melt index (I2) that is within ±0.5 g/10 min of the melt index of component a; and wherein the Reduction in APRR (%)={[(APRRfor (SC))−(APRR for (C))]/(APRR for (SC))}×100.
   D] The process of any one of A]-C] (A] through C]) above, wherein the crosslinked, foamed composition has an acetophenone residual ratio (APRR) ≤12%, or ≤11%, or ≤10%, or ≤9.0%, or ≤8.0%, or ≤7.0%, or ≤6.0%. The APRR value is based in part on the DCP loading in the first composition.
   E] The process of any one of A]-D] above, wherein the crosslinked, foamed composition has a gel content (Gel %) ≥30 wt %, or ≥35 wt %, or ≥40 wt %, or ≥45 wt %, or ≥50 wt %, or ≥55 wt %, or ≥60 wt %, or ≥65 wt %, or ≥70 wt %, or ≥72 wt %, or ≥74 wt %, or ≥76 wt %.
   F] The process of any one of A]-E] above, wherein the crosslinked, foamed composition has a gel content (Gel %) ≤85 wt %, or ≤84 wt %, or ≤83 wt %, or ≤82 wt %, or ≤81 wt %.
   G] The process of any one of A]-F] above, wherein component b is selected from Formula P:

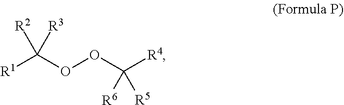

where R1 is a substituted or unsubstituted aryl group; R4 is a substituted or unsubstituted aryl group; R2, R3, R5 and R6 are each, independently, alkyl or H, or a C1-C5 alkyl or H, or methyl or H.
H] The process of G] above, wherein, for Formula P, R1 is an unsubstituted aryl group, and further phenyl; and R4 is an unsubstituted aryl group, and further phenyl.
I] The process of G] or H] above, wherein Formula P is di-cumylperoxide:

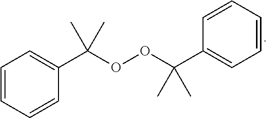 [SMILES: CC(C)(OOC(C)(C)c1ccccc1)c1ccccc1]

J] The process of any one of A]-I] above, wherein component c is selected from inorganic blowing agents, organic blowing agents, and combinations thereof, and further from organic blowing agents.
K] The process of any one of A]-J] above, wherein component c is selected from azodicarbonamide, azodicarbonamide modified with a metal oxide or a metal salt, benzenesulfonyl hydrazide, dinitrosopentamethylenetetramine, sodium bicarbonate, ammonium carbonate, water, nitrogen gas, or carbon dioxide gas.
L] The process of any one of A]-K] above, wherein the olefin/silane interpolymer of component a is an ethylene/silane interpolymer, or an ethylene/alpha-olefin/silane interpolymer, or an ethylene/alpha-olefin/silane terpolymer.
M] The process of L] above, wherein the alpha-olefin of the ethylene/alpha-olefin/silane interpolymer or terpolymer is a C3-C20 alpha-olefin, or a C3-C10 alpha-olefin, or a C3-C8 alpha-olefin, or one of propylene, 1-butene, 1-hexene or 1-octene, or one of propylene, 1-butene, or 1-octene, or one of 1-butene or 1-octene, or 1-octene.
N] The process of any one of A]-M] above, wherein the olefin/silane interpolymer of component a comprises, in polymerized form, ≥0.10 wt %, or ≥0.20 wt %, or ≥0.40 wt %, or ≥0.60 wt %, or ≥0.80 wt %, or ≥1.0 wt %, or ≥1.2 wt %, or ≥1.3 wt %, or ≥1.4 wt %, or ≥1.5 wt % of the silane, based on the weight of the interpolymer.
O] The process of any one of A]-N] above, wherein the interpolymer of component a comprises, in polymerized form, ≤40 wt %, or ≤30 wt %, or ≤20 wt %, or ≤10 wt %, or ≤8.0 wt %, or ≤6.0 wt %, or ≤5.0 wt %, or ≤4.5 wt %, or ≤4.0 wt % of the silane, based on the weight of the interpolymer.
P] The process of any one of A]-O] above, wherein the olefin/silane interpolymer of component a has a density ≥0.855 g/cc, or ≥0.856 g/cc, or ≥0.857 g/cc, or ≥0.858 g/cc, or ≥0.859 g/cc, or ≥0.860 g/cc, or ≥0.861 g/cc, or ≥0.862 g/cc, or ≥0.863 g/cc, or ≥0.864 g/cc, or ≥0.865 g/cc, or ≥0.866 g/cc, or ≥0.867 g/cc, or ≥0.868 g/cc, or ≥0.869 g/cc, or ≥0.870 g/cc (1 cc=1 cm³).
Q] The process of any one of A]-P] above, wherein interpolymer of component a has a density ≤0.940 g/cc, or ≤0.930 g/cc, or ≤0.920 g/cc, or ≤0.910 g/cc, or ≤0.900 g/cc, or ≤0.890 g/cc, or ≤0.888 g/cc, or ≤0.886 g/cc, or ≤0.884 g/cc, or ≤0.882 g/cc, or ≤0.881 g/cc, or ≤0.880 g/cc, or ≤0.879 g/cc.
R] The process of any one of A]-Q] above, wherein the olefin/silane interpolymer of component a has a melt index (I2) ≥0.2 g/10 min, or ≥0.5 g/10 min, or ≥0.6 g/10 min, or ≥0.7 g/10 min, or ≥0.8 g/10 min.
S] The process of any one of A]-R] above, wherein interpolymer of component a has a melt index (I2) ≤100 g/10 min, or ≤50 g/10 min, or ≤20 g/10 min, or ≤18 g/10 min, or ≤16 g/10 min, or ≤14 g/10 min, or ≤12 g/10 min, or ≤10 g/10 min, or ≤8.0 g/10 min, or ≤6.0 g/10 min, or ≤4.0 g/10 min, or ≤2.0 g/10 min, or ≤1.0 g/10 min.
T] A crosslinked, foam composition formed by the process of any one of A]-S] above.
U] A first composition comprising the following components:
a) at least one olefin/silane interpolymer comprising at least one Si—H group,
b) at least one peroxide, and
c) at least one blowing agent. Further component a comprises one olefin/silane interpolymer comprising at least one Si—H group.
   V] A crosslinked, foamed composition formed from the first composition of U] above, and further formed by thermally treating first composition of U] above.
   W] The crosslinked, foamed composition of V] above, wherein the crosslinked, foam composition (C) has a reduced acetophenone residual ratio (APRR), as compared to a similar composition (SC) that comprises the same components, except that the olefin/silane interpolymer of component a is replaced with a similar olefin-based polymer that contains the same monomer types as the interpolymer of component a, except the olefin-based polymer does not contain the “at least one Si—H group,” and wherein the similar olefin-based polymer has a density that is within ±0.005 g/cc of the density of component a, and has a melt index (I2) that is within ±0.5 g/10 min of the melt index of component a; and wherein the Reduction in APRR (%)={[(APRR for (SC))−(APRR for (C))]/(APRR for (SC))}×100.
   X] The crosslinked, foamed composition of V] or W] above, wherein the crosslinked foamed composition has an acetophenone residual ratio (APRR) ≤12%, or ≤11%, or ≤10%, or ≤9.0%, or ≤8.0%, or ≤7.0%, or ≤6.0%.
   Y] The crosslinked, foamed composition of any one of V]-X] above, wherein the crosslinked, foamed composition has a gel content (Gel %) ≥30 wt %, or ≥35 wt %, or ≥40 wt %, or ≥45 wt %, or ≥50 wt %, or ≥55 wt %, or ≥60 wt %, or ≥65 wt %, or ≥70 wt %, or ≥72 wt %, or ≥74 wt %, or ≥76 wt %.
   Z] The crosslinked, foamed composition of any one of V]-Y] above, wherein the crosslinked, foamed composition has a gel content (Gel %) ≤85 wt %, or ≤84 wt %, or ≤83 wt %, or ≤82 wt %, or ≤81 wt %.
   A2] The first composition of U] above, or the crosslinked, foamed composition of any one of V]-Z] above, wherein component b is selected from Formula P:

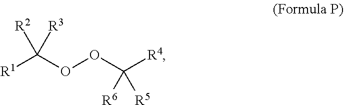

where R1 is a substituted or unsubstituted aryl group; R4 is a substituted or unsubstituted aryl group; R2, R3, R5 and R6 are each, independently, alkyl or H, or a C1-C5 alkyl or H, or methyl or H.
B2] The first composition of U] or A2] above, or the crosslinked, foamed composition of any one of V]-A2] above, wherein, for Formula 1, R1 is an unsubstituted aryl group, and further phenyl; and R4 is an unsubstituted aryl group, and further phenyl.
C2] The first composition of U], A2] or B2] above, or the crosslinked, foamed composition of any one of V]-B2] above, wherein Formula P is di-cumylperoxide.
D2] The first composition of any one U] or A2]-C2] above, or the crosslinked, foamed composition of any one of V]-C2] above, wherein component c is selected from inorganic blowing agents, organic blowing agents, and combinations thereof, and further from organic blowing agents.
E2] The first composition of any one U] or A2]-D2] above, or the crosslinked, foamed composition of any one of V]-D2] above, wherein component c is selected from azodicarbonamide, azodicarbonamide modified with a metal oxide or a metal salt, benzenesulfonyl hydrazide, dinitrosopentamethylenetetramine, sodium bicarbonate, ammonium carbonate, water, nitrogen gas, or carbon dioxide gas.
F2] The first composition of any one U] or A2]-E2] above, or the crosslinked, foamed composition of any one of V]-E2] above, wherein the olefin/silane interpolymer of component a is an ethylene/silane interpolymer, or an ethylene/alpha-olefin/silane interpolymer, or an ethylene/alpha-olefin/silane terpolymer.
G2] The first composition of F2] above, or the crosslinked, foamed composition of F2] above, wherein the alpha-olefin of the ethylene/alpha-olefin/silane interpolymer or terpolymer is a C3-C20 alpha-olefin, or a C3-C10 alpha-olefin, or a C3-C8 alpha-olefin, or one of propylene, 1-butene, 1-hexene or 1-octene, or one of propylene, 1-butene, or 1-octene, or one of 1-butene or 1-octene, or 1-octene.
H2] The first composition of any one U] or A2]-G2] above, or the crosslinked, foamed composition of any one of V]-G2] above, wherein the olefin/silane interpolymer of component a comprises, in polymerized form, ≥0.10 wt %, or ≥0.20 wt %, or ≥0.40 wt %, or ≥0.60 wt %, or ≥0.80 wt %, or ≥1.0 wt %, or ≥1.2 wt %, or ≥1.3 wt %, or ≥1.4 wt %, or ≥1.5 wt % of the silane, based on the weight of the interpolymer.
I2] The first composition of any one U] or A2]-H2] above, or the crosslinked, foamed composition of any one of V]-H2] above, wherein the interpolymer of component a comprises, in polymerized form, ≤40 wt %, or ≤30 wt %, or ≤20 wt %, or ≤10 wt %, or ≤8.0 wt %, or ≤6.0 wt %, or ≤5.0 wt %, or ≤4.5 wt %, or ≤4.0 wt % of the silane, based on the weight of the interpolymer.
J2] The first composition of any one U] or A2]-I2] above, or the crosslinked, foamed composition of any one of V]-I2] above, wherein olefin/silane interpolymer of component a has a density ≥0.855 g/cc, or ≥0.856 g/cc, or ≥0.857 g/cc, or ≥0.858 g/cc, or ≥0.859 g/cc, or ≥0.860 g/cc, or ≥0.861 g/cc, or ≥0.862 g/cc, or ≥0.863 g/cc, or ≥0.864 g/cc, or ≥0.865 g/cc, or ≥0.866 g/cc, or ≥0.867 g/cc, or ≥0.868 g/cc, or ≥0.869 g/cc, or ≥0.870 g/cc.
K2] The first composition of any one U] or A2]-J2] above, or the crosslinked, foamed composition of any one of V]-J2] above, wherein the interpolymer of component a has a density ≤0.940 g/cc, or ≤0.930 g/cc, or ≤0.920 g/cc, or ≤0.910 g/cc, or ≤0.900 g/cc, or ≤0.890 g/cc, or ≤0.888 g/cc, or ≤0.886 g/cc, or ≤0.884 g/cc, or ≤0.882 g/cc, or ≤0.881 g/cc, or ≤0.880 g/cc, or ≤0.879 g/cc.
L2] The first composition of any one U] or A2]-K2] above, or the crosslinked, foamed composition of any one of V]-K2] above, wherein olefin/silane interpolymer of component a has a melt index (I2) ≥0.2 g/10 min, or ≥0.5 g/10 min, or ≥0.6 g/10 min, or ≥0.7 g/10 min, or ≥0.8 g/10 min.
M2] The first composition of any one U] or A2]-L2] above, or the crosslinked, foamed composition of any one of V]-L2] above, wherein the interpolymer of component a has a melt index (I2) ≤100 g/10 min, or ≤50 g/10 min, or ≤20 g/10 min, or ≤18 g/10 min, or ≤16 g/10 min, or ≤14 g/10 min, or ≤12 g/10 min, or ≤10 g/10 min, or ≤8.0 g/10 min, or ≤6.0 g/10 min, or ≤4.0 g/10 min, or ≤2.0 g/10 min, or ≤1.0 g/10 min.
A3] The process of any one of A]-S] above, or the first composition of any one of U] or A2]-M2] above, or the crosslinked, foamed composition of any one of T] or V]-M2] above, wherein, the silane is derived from a silane monomer selected from Formula 1:

A-(SiBC—O)ₓ—Si-EFH (Formula 1),
where A is an alkenyl group, B is a hydrocarbyl group or hydrogen, C is a hydrocarbyl group or hydrogen, and where B and C may be the same or different;
H is hydrogen, and x≥0;
E is a hydrocarbyl group or hydrogen, F is a hydrocarbyl group or hydrogen, and where E and F may be the same or different.
   B3] The process of A3] above, or the first composition of A3] above, or the crosslinked, foamed composition of A3] above, wherein, for Formula 1, x is from 0 to 10, or from 0 to 8, or from 0 to 6, or from 0 to 4, or from 0 to 2, or 0 or 1, or 0.
   C3] The process of A3] or B3] above, or the first composition of A3] or B3] above, or the crosslinked, foamed composition of A3] or B3] above, wherein, for Formula 1, A is a C2-C50 alkenyl group, or a C2-C40 alkenyl group, or a C2-C30 alkenyl group, or a C2-C20 alkenyl group.
   D3] The process of any one of A3]-C3] above, or the first composition of any one of A3]-C3] above, or the crosslinked, foamed composition of any one of A3]-C3] above, wherein, for Formula 1, A is selected from the following structures i)-iv):
i) R¹R²C═CR³—, where each of R¹, R² is independently hydrogen or an alkyl group, and R³ is hydrogen, and wherein R¹ and R² may be the same or different;
ii) R¹R²C═CR³—(CR⁴R⁵)ₙ—, where each of R¹, R², R⁴, R⁵ is independently hydrogen, or an alkyl group, and R³ is hydrogen, and wherein two or more from R¹, R², R⁴, R⁵ may be the same or different, and n is from 1 to 10, or 1 to 8, or 1 to 6, or 1 to 4, or 1 to 2, or 1;

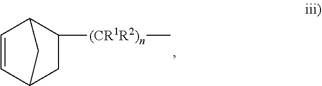

where each of R¹ and R² is independently hydrogen or an alkyl group, and wherein R¹, and R² may be the same or different, and n is from 1 to 10, or 1 to 8, or 1 to 6, or 1 to 4, or 1 to 2, or 1; or

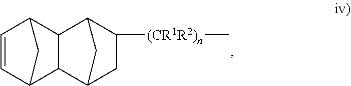

where each of R¹ and R² is independently hydrogen or an alkyl group, and wherein R¹, and R² may be the same or different, and n is from 1 to 10, or 1 to 8, or 1 to 6, or 1 to 4, or 1 to 2, or 1.
E3] The process of any one of A3]-D3] above, or the first composition of any one of A3]-D3] above, or the crosslinked, foamed composition of any one of A3]-D3] above, wherein, for Formula 1, A is selected from the following structures i)-iv):
i) H₂C═CH—;
ii) H₂C═CH—(CH₂)ₙ—, where n is from 1 to 10, or 1 to 8, or 1 to 6, or 1 to 4, or 1 to 2, or 1;

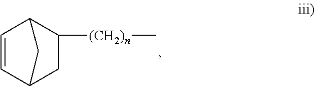

where n is from 1 to 10, or 1 to 8, or 1 to 6, or 1 to 4, or 1 to 2, or 1; or

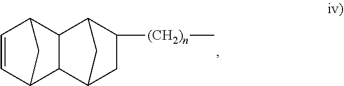

where n is from 1 to 10, or 1 to 8, or 1 to 6, or 1 to 4, or 1 to 2, or 1.
F3] The process of any one of A3]-E3] above, or the first composition of any one of A3]-E3] above, or the crosslinked, foamed composition of any one of A3]-E3] above, wherein, for Formula 1, B is an alkyl, or a C1-C5 alkyl, or a C1-C4 alkyl, or a C1-C3 alkyl, or a C1-C2 alkyl, or methyl.
G3] The process of any one of A3]-F3] above, or the first composition of any one of A3]-F3] above, or the crosslinked, foamed composition of any one of A3]-F3] above, wherein, for Formula 1, C is an alkyl, or a C1-C5 alkyl, or a C1-C4 alkyl, or a C1-C3 alkyl, or a C1-C2 alkyl, or methyl.
H3] The process of any one of A3]-G3] above, or the first composition of any one of A3]-G3] above, or the crosslinked, foamed composition of any one of A3]-G3] above, wherein, for Formula 1, E is an alkyl, or a C1-C5 alkyl, or a C1-C4 alkyl, or a C1-C3 alkyl, or a C1-C2 alkyl, or methyl.
I3] The process of any one of A3]-H3] above, or the first composition of any one of A3]-H3] above, or the crosslinked, foamed composition of any one of A3]-H3] above, wherein, for Formula 1, F is an alkyl, or a C1-C5 alkyl, or a C1-C4 alkyl, or a C1-C3 alkyl, or a C1-C2 alkyl, or methyl.
J3] The process of any one of A3]-I3] above, or the first composition of any one of A3]-I3] above, or the crosslinked, foamed composition of any one of A3]-I3] above, wherein Formula 1 is selected from compounds s1) through s16):

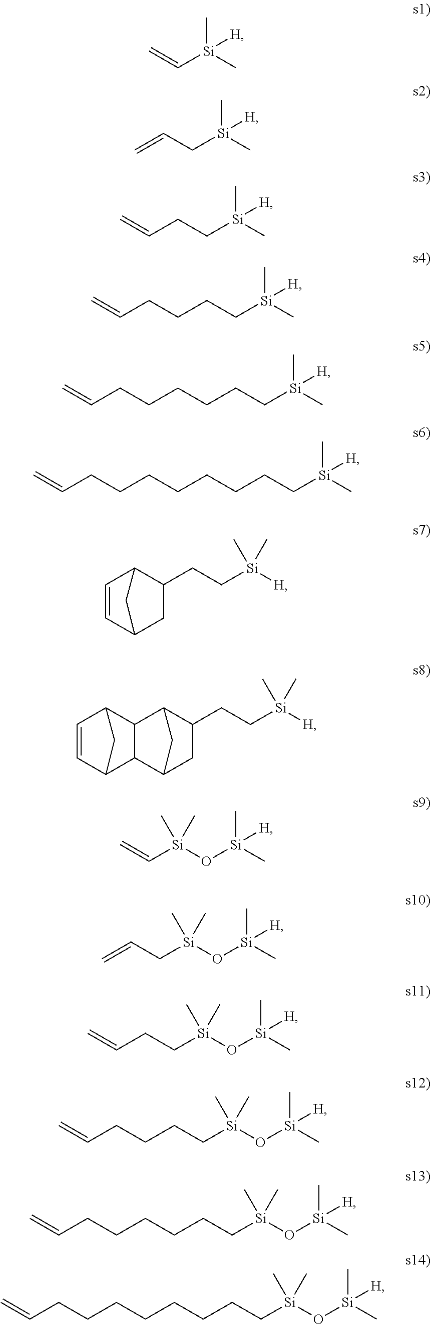

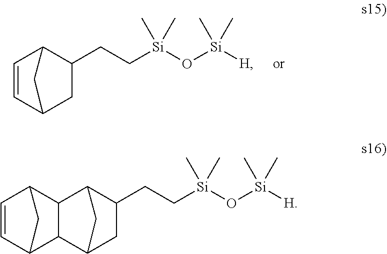

K3] The process of any one of A3]-J3] above, or the first composition of any one of A3]-J3] above, or the crosslinked, foamed composition of any one of A3]-J3] above, wherein Formula 1 is selected from structures s1) to s8), as described above.
L3] The process of any one of A3]-J3] above, or the first composition of any one of A3]-J3] above, or the crosslinked, foamed composition of any one of A3]-J3] above, wherein Formula 1 is selected from structures s9) to s16), as described above.
M3] The process of any one of A]-S] or A3]-L3] above, or the first composition of any one of U], A2]-M2] or A3]-L3] above, or the crosslinked, foamed composition of any one of T], V]-M2] or A3]-L3] above, wherein the silane is derived from a silane monomer selected from the following compounds: allyldimethylsilane, 3-butenyldimethyl-silane, 1-(but-3-en-1-yl)-1,1,3,3-tetramethyl-disiloxane (BuMMH), 1-(hex-5-en-1-yl)-1,1,3,3-tetramethyldisiloxane (HexMMH), (2-bicyclo-[2.2.1]hept-5-en-2-yl)ethyl)dimethyl-silane (NorDMS) or 1-(2-bicyclo[2.2.1]hept-5-en-2-yl)ethyl)-1,1,3,3-tetramethyldisiloxane (NorMMH), or any combination thereof.
N3] The process of any one of A]-S] or A3]-M3] above, or the first composition of any one of U], A2]-M2] or A3]-M3] above, or the crosslinked, foamed composition of any one of T], V]-M2] or A3]-M3] above, wherein the olefin/silane interpolymer of component a has a melting temperature (Tₘ) ≥56° C., ≥58° C., ≥60° C., ≥61° C., ≥62° C. and/or ≤85° C., or ≤80° C. or ≤78° C., or ≤76° C., or ≤74° C., or ≤72° C., or ≤70° C., or ≤68° C.
O3] The process of any one of A]-S] or A3]-N3] above, or the first composition of any one of U], A2]-M2] or A3]-N3] above, or the crosslinked, foamed composition of any one of T], V]-M2] or A3]-N3] above, wherein the olefin/silane interpolymer of component a has a molecular weight distribution (MWD=Mw/Mn) ≥1.5, or ≥1.6, or ≥1.7, or ≥1.8, or ≥1.9, or ≥2.0 and/or ≤5.0, or ≤4.5, or ≤4.0, or ≤3.5, or ≤3.0, or ≤2.8, or ≤2.7, or ≤2.6, or ≤2.5, or ≤2.4, or ≤2.3.
P3] The process of any one of A]-S] or A3]-O3] above, or the first composition of any one of U], A2]-M2] or A3]-O3] above, or the crosslinked, foamed composition of any one of T], V]-M2] or A3]-O3] above, wherein the olefin/silane interpolymer of component a has a number average molecular weight (Mn) ≥10,000 g/mol, or ≥15,000 g/mol, or ≥20,000 g/mol, or ≥25,000 g/mol, or ≥30,000 g/mol, or ≥32,000 g/mol, or ≥35,000 g/mol, or ≥38,000 g/mol, or ≥40,000 g/mol and/or ≤100,000 g/mol, or ≤90,000 g/mol, or ≤80,000 g/mol, or ≤75,000 g/mol, or ≤70,000 g/mol, or ≤65,000 g/mol, or ≤60,000 g/mol.
Q3] The process of any one of A]-S] or A3]-P3] above, or the first composition of any one of U], A2]-M2] or A3]-P3] above, or the crosslinked, foamed composition of any one of T], V]-M2] or A3]-P3] above, wherein the olefin/silane interpolymer of component a has a weight average molecular weight (Mw) ≥20,000 g/mol, or ≥30,000 g/mol, or ≥40,000 g/mol, or ≥50,000 g/mol, or ≥60,000 g/mol, or ≥70,000 g/mol, or ≥80,000 g/mol and/or ≤300,000 g/mol, or ≤250,000 g/mol, or ≤200,000 g/mol, or ≤150,000 g/mol, or ≤120,000 g/mol, or ≤110,000 g/mol.
R3] The process of any one of A]-S] or A3]-Q3] above, or the first composition of any one of U], A2]-M2] or A3]-Q3] above, or the crosslinked, foamed composition of any one of T], V]-M2] or A3]-Q3] above, wherein the olefin/silane interpolymer of component a has an I10/I2 ratio ≥6.0, or ≥6.5, or ≥7.0, or ≥7.5, or ≥8.0 and/or ≤30, or ≤25, or ≤20, or ≤15.
S3] The process of any one of A]-S] or A3]-R3] above, or the first composition of any one of U], A2]-M2] or A3]-R3] above, or the crosslinked, foamed composition of any one of T], V]-M2] or A3]-R3] above, wherein the first composition comprises component d, at least one filler.
T3] The process of S3] above, or the first composition of S3] above, or the crosslinked, foamed composition of S3] above, wherein component d is selected from inorganic fillers and/or organic fillers, and further from talc, glass fiber, carbon black, carbon fiber, wood fiber, clay, calcium carbonate, TiO2 or any combination thereof, and further from talc, glass fiber, carbon black, calcium carbonate, TiO2 or any combination thereof.
U3] The process of S3] or T3] above, or the first composition of S3] or T3] above, or the crosslinked, foamed composition of any one of S3] or T3] above, wherein the weight ratio of component d to component a ≥0.010, or ≥0.020, or ≥0.030, or ≥0.040, or ≥0.045, or ≥0.050 and/or ≤1.00, or ≤0.500, or ≤0.400, or ≤0.300, or ≤0.250, or ≤0.200, or ≤0.150, or ≤0.100, or ≤0.080
V3] The process of any one of A]-S] or A3]-U3] above, or the first composition of any one of U], A2]-M2] or A3]-U3] above, or the crosslinked, foamed composition of any one of T], V]-M2] or A3]-U3] above, wherein component a is present in an amount ≥25.0 wt %, or ≥30.0 wt %, ≥35.0 wt %, or ≥40.0 wt %, or ≥45.0 wt %, or ≥50.0 wt %, ≥55.0 wt %, or ≥60.0 wt %, or ≥65.0 wt %, or ≥70.0 wt %, or ≥75.0 wt %, ≥80.0 wt %, or ≥85.0 wt %, or ≥86.0 wt %, or ≥87.0 wt %, ≥88.0 wt %, or ≥89.0 wt %, or ≥90.0 wt %, and/or ≤99.0 wt %, or ≤98.0 wt %, or ≤96.0 wt %, or ≤94.0 wt %, or ≤92.0 wt %, or ≤91.5 wt %, based on the weight of the first composition.
W3] The process of any one of A]-S] or A3]-V3] above, or the first composition of any one of U], A2]-M2] or A3]-V3] above, or the crosslinked, foamed composition of any one of T], V]-M2] or A3]-V3] above, wherein component b is present in an amount ≥0.10 wt %, ≥0.15 wt %, ≥0.17 wt %, or ≥0.20 wt %, or ≥0.22 wt %, or ≥0.24 wt %, or ≥0.26 wt %, and/or ≤0.50 wt %, or ≤0.45 wt %, or ≤0.42 wt %, or ≤0.38 wt %, or ≤0.37 wt %, based on the weight of the first composition.
X3] The process of any one of A]-S] or A3]-W3] above, or the first composition of any one of U], A2]-M2] or A3]-W3] above, or the crosslinked, foamed composition of any one of T], V]-M2] or A3]-W3] above, wherein the weight ratio of component a to component bis amount ≥150, or ≥170, or ≥200, or ≥210, or ≥220, or ≥230, or ≥235, or ≥240, or ≥245, and/or ≤400, or ≤370, or ≤350, or ≤345, or ≤340, or ≤338, or ≤335.
Y3] The process of any one of A]-S] or A3]-X3] above, or the first composition of any one of U], A2]-M2] or A3]-X3] above, or the crosslinked, foamed composition of any one of T], V]-M2] or A3]-X3] above, wherein component c is present in an amount ≥0.50 wt %, or ≥1.0 wt %, ≥1.2 wt %, or ≥1.4 wt %, or ≥1.6 wt %, or ≥1.8 wt %, ≥2.0 wt %, or ≥2.2 wt %, and/or ≤5.0 wt %, or ≤4.5 wt %, or ≤4.0 wt %, or ≤3.8 wt %, or ≤3.6 wt %, or ≤3.4 wt %, or ≤3.2 wt %, or ≤3.0 wt %, or ≤2.8 wt %, based on the weight of the first composition.
Z3] The process of any one of A]-S] or A3]-Y3] above, or the first composition of any one of U], A2]-M2] or A3]-Y3] above, or the crosslinked, foamed composition of any one of T], V]-M2] or A3]-Y3] above, wherein the sum of component a and component b is present in an amount ≥25.0 wt %, or ≥30.0 wt %, ≥35.0 wt %, or ≥40.0 wt %, or ≥45.0 wt %, or ≥50.0 wt %, ≥55.0 wt %, or ≥60.0 wt %, or ≥65.0 wt %, or ≥70.0 wt %, or ≥75.0 wt %, ≥80.0 wt %, or ≥85.0 wt %, ≥86.0 wt %, or ≥88.0 wt %, or ≥89.0 wt %, or ≥90.0 wt %, or ≥90.2 wt %, and/or ≤95.0 wt %, or ≤94.0 wt %, or ≤93.0 wt %, or ≤92.5 wt %, or ≤92.0 wt %, or ≤91.5 wt %, based on the weight of the first composition.
A4] The process of any one of A]-S] or A3]-Z3] above, or the first composition of any one of U], A2]-M2] or A3]-Z3] above, or the crosslinked, foamed composition of any one of T], V]-M2] or A3]-Z3] above, wherein the sum of component a, component b and component c is present in an amount ≥25.0 wt %, or ≥30.0 wt %, ≥35.0 wt %, or ≥40.0 wt %, or ≥45.0 wt %, or ≥50.0 wt %, ≥55.0 wt %, or ≥60.0 wt %, or ≥65.0 wt %, or ≥70.0 wt %, or ≥75.0 wt %, ≥80.0 wt %, or ≥85.0 wt %, ≥86.0 wt %, or ≥88.0 wt %, or ≥90.0 wt %, ≥91.0 wt %, or ≥92.0 wt %, or ≥92.5 wt %, or ≥93.0 wt %, or ≥93.5 wt %, and/or ≤98.0 wt %, or ≤96.0 wt %, or ≤95.5 wt %, or ≤95.0 wt %, or ≤94.5 wt %, or ≤94.0 wt %, based on the weight of the first composition.
B4] The process of any one of A]-S] or A3]-A4] above, or the first composition of any one of U], A2]-M2] or A3]-A4] above, or the crosslinked, foamed composition of any one of T], V]-M2] or A3]-A4] above, wherein the first composition comprises component e (at least one “Zn containing” compound), and further component e is selected from ZnO and/or Zn stearate, and further ZnO and Zn stearate.
C4] The process of any one of A]-S] or A3]-B4] above, or the first composition of any one of U], A2]-M2] or A3]-B4] above, or the crosslinked, foamed composition of any one of T], V]-M2] or A3]-B4] above, wherein the first composition further comprises a thermoplastic polymer, different from the olefin/silane interpolymer of component a in one or more features, such as monomer(s) types, monomer(s) amounts, monomer(s) distributions, density, melt index (I2), Mn, Mw, MWD, or any combination thereof, and further, in one or more features, such as monomer(s) types, monomer(s) amounts, monomer(s) distributions, density, melt index (I2), or any combination thereof. Further thermoplastic polymer is selected from an olefin-based polymer, further an ethylene-base polymer or a propylene-based polymer, further an ethylene-based polymers.
D4] The process of any one of A]-S] or A3]-C4] above, or the first composition of any one of U], A2]-M2] or A3]-C4] above, or the crosslinked, foamed composition of any one of T], V]-M2] or A3]-C4] above, wherein the first composition further comprises an ethylene/alpha-olefin interpolymer, and further an ethylene/alpha-olefin copolymer; or an ethylene/alpha-olefin multi-block interpolymer, and further an ethylene/alpha-olefin multi-block copolymer.
E4] The process of any one of A]-S] or A3]-C4] above, or the first composition of any one of U], A2]-M2] or A3]-C4] above, or the crosslinked, foamed composition of any one of T], V]-M2] or A3]-C4] above, wherein the first composition further comprises a polymer selected from the following: an ethylene/alpha-olefin/nonconjugated diene interpolymer, an ethylene/alpha-olefin copolymer, an ethylene/alpha-olefin multi-block interpolymer, a polyethylene homopolymer, a styrene/ethylene interpolymer (for example, a SEBS), an EVA, or any combination thereof, and further an ethylene/alpha-olefin/nonconjugated diene interpolymer, an EVA, or a combination thereof, and further an EVA.
F4] The process of D4] or E4] above, or first composition of D4] or E4] above, or the crosslinked, foamed composition of D4] or E4] above, wherein the alpha-olefin of each interpolymer or copolymer is, independently, a C3-C20 alpha-olefin, or a C3-C10 alpha-olefin, or a C3-C8 alpha-olefin, or one of propylene, 1-butene, 1-hexene or 1-octene, or one of propylene, 1-butene, or 1-octene, or one of 1-butene or 1-octene, or 1-octene.
G4] The process of any one of A]-S] or A3]-F4] above, or the first composition of any one of U], A2]-M2] or A3]-F4] above, or the crosslinked, foamed composition of any one of T], V]-M2] or A3]-F4] above, wherein the first composition is thermally treated at a temperature ≥150° C., or ≥155° C., or ≥160° C., or ≥165° C., or ≥170° C., or ≥175° C.
H4] The process of any one of A]-S] or A3]-G4] above, or the first composition of any one of U], A2]-M2] or A3]-G4] above, or the crosslinked, foamed composition of any one of T], V]-M2] or A3]-G4] above, wherein the first composition is thermally treated at a temperature ≤200° C., or ≤195° C., or ≤190° C., or ≤185° C., or ≤180° C.
I4] The process of any one of A]-S] or A3]-H4] above, or the crosslinked, foamed composition of any one of T], V]-M2] or A3]-H4] above, wherein the crosslinked, foamed composition has a Tensile Strength ≥1.70 MPa, ≥1.75 MPa, or ≥1.80 MPa, or ≥1.85 MPa, or ≥1.90 MPa, or ≥1.95 MPa, and/or ≤10.0 MPa, or ≤5.00 MPa, or ≤4.00 MPa, or ≤3.50 MPa, or ≤3.00 MPa, or ≤2.50 MPa.
J4] The process of any one of A]-S] or A3]-I4] above, or the crosslinked, foamed composition of any one of T], V]-M2] or A3]-I4] above, wherein the crosslinked, foamed composition has a 100% Modulus ≥0.30 MPa, or ≥0.35 MPa, or ≥0.40 MPa, or ≥0.45 MPa, or ≥0.50 MPa, and/or ≤0.90 MPa, or ≤0.80 MPa, or ≤0.70 MPa, or ≤0.67 MPa.
K4] The process of any one of A]-S] or A3]-J4] above, or the crosslinked, foamed composition of any one of T], V]-M2] or A3]-J4] above, wherein the crosslinked, foamed composition has an % Elongation ≥370, or ≥375, or ≥380, or ≥385, or ≥390, and/or ≤470, or ≤460, or ≤450, or 445, or ≤440, or ≤435, or ≤430.
L4] The process of any one of A]-S] or A3]-K4] above, or the crosslinked, foamed composition of any one of T], V]-M2] or A3]-K4] above, wherein the crosslinked, foamed composition has an % Rebound ≥50, or ≥55, or ≥60, or ≥65, or ≥67, and/or ≤100, or ≤90, or ≤80, or ≤78, or ≤76, or 74, or ≤72.
M4] An article comprising at least one component formed from the first composition of any one of U], A2]-M2] or A3]-H4] above.
N4] An article comprising at least one component formed from the crosslinked, foamed composition of any one of T], V]-M2] or A3]-L4] above.
O4] The article of M4] or N4] above, wherein the article is a shoe, a sneaker, a boot or a sandal.
P4] The article of M4] or N4] above, wherein the article is a footwear component, an automotive part, a window profile, a tire, a tube, a solar cell module, a cable, or a roofing membrane.

### Test Methods

### Gel Permeation Chromatography

The chromatographic system consisted of a PolymerChar GPC-IR (Valencia, Spain) high temperature GPC chromatograph, equipped with an internal IR5 infra-red detector (IR5). The autosampler oven compartment was set at 160° Celsius, and the column compartment was set at 150° Celsius. The columns were four AGILENT “Mixed A” 30 cm, 20-micron linear mixed-bed columns. The chromatographic solvent was 1,2,4-trichloro-benzene, which contained 200 ppm of butylated hydroxytoluene (BHT). The solvent source was nitrogen sparged. The injection volume used was 200 microliters, and the flow rate was 1.0 milliliters/minute.

Calibration of the GPC column set was performed with 21 narrow molecular weight distribution polystyrene standards, with molecular weights ranging from 580 to 8,400,000, and which were arranged in six “cocktail” mixtures, with at least a decade of separation between individual molecular weights. The standards were purchased from Agilent Technologies. The polystyrene standards were prepared at “0.025 grams in 50 milliliters” of solvent, for molecular weights equal to, or greater than, 1,000,000, and at “0.05 grams in 50 milliliters” of solvent, for molecular weights less than 1,000,000. The polystyrene standards were dissolved at 80 degrees Celsius, with gentle agitation, for 30 minutes. The polystyrene standard peak molecular weights were converted to polyethylene molecular weights using Equation 1 (as described in Williams and Ward, J. Polym. Sci., Polym. Let., 6, 621 (1968)):

$${M}_{polyet hylene} = A \times {( {M}_{polyestyrene} )}^{B} , \qquad ( EQ 1 )$$

where M is the molecular weight, A has a value of 0.4315 and B is equal to 1.0.

A fifth order polynomial was used to fit the respective polyethylene-equivalent calibration points. A small adjustment to A (from approximately 0.375 to 0.445) was made to correct for column resolution and band-broadening effects, such that linear homopolymer polyethylene standard is obtained at 120,000 Mw. The total plate count of the GPC column set was performed with decane (prepared at “0.04 g in 50 milliliters” of TCB, and dissolved for 20 minutes with gentle agitation.) The plate count (Equation 2) and symmetry (Equation 3) were measured on a 200 microliter injection according to the following equations:

$$Plate Count = 5.54 * {( \frac{( R {V}_{Peak Max}}{Peak Widt h at \frac{1}{2} height} )}^{2} , \qquad ( EQ 2 )$$

where RV is the retention volume in milliliters, the peak width is in milliliters, the peak max is the maximum height of the peak, and ½ height is ½ height of the peak maximum; and

$$Symmetry = \frac{( Rear Peak R {V}_{one tent h height} - R {V}_{Peak max} )}{( R {V}_{Peak max} - Front Peak R {V}_{one tent h height} )} , \qquad ( EQ 3 )$$

where RV is the retention volume in milliliters, and the peak width is in milliliters, Peak max is the maximum position of the peak, one tenth height is 1/10 height of the peak maximum, and where rear peak refers to the peak tail at later retention volumes than the peak max, and where front peak refers to the peak front at earlier retention volumes than the peak max. The plate count for the chromatographic system should be greater than 18,000, and symmetry should be between 0.98 and 1.22.

Samples were prepared in a semi-automatic manner with the PolymerChar “Instrument Control” Software, wherein the samples were weight-targeted at “2 mg/ml,” and the solvent (contained 200 ppm BHT) was added to a pre nitrogen-sparged, septa-capped vial, via the PolymerChar high temperature autosampler. The samples were dissolved for two hours at 160° Celsius under “low speed” shaking.

The calculations of Mn(GPC), Mw(GPC), and Mz(GPC) were based on GPC results using the internal IR5 detector (measurement channel) of the PolymerChar GPC-IR chromatograph according to Equations 4-6, using PolymerChar GPCOne™ software, the baseline-subtracted IR chromatogram at each equally-spaced data collection point (i), and the polyethylene equivalent molecular weight obtained from the narrow standard calibration curve for the point (i) from Equation 1. Equations 4-6 are as follows:

$${Mn}_{( GPC )} = \frac{{Σ}^{i} {IR}_{i}}{{Σ}^{i} ( {IR}_{i} / {M}_{{polyethylene}_{i}} )} , \qquad ( EQ 4 )$$

$${Mw}_{( GPC )} = \frac{{Σ (}^{i} {IR}_{i} ⋆ {M}_{{polyethylene}_{i}} )}{{Σ}^{i} {IR}_{i}} , \qquad ( EQ 5 )$$

$$and$$

$${Mz}_{( GPC )} = \frac{{Σ (}^{i} {IR}_{i} ⋆ {{M}_{{polyethylene}_{i}}}^{2} )}{{Σ (}^{i} {IR}_{i} ⋆ {M}_{{polyethylene}_{i}} )} . \qquad ( EQ 6 )$$

In order to monitor the deviations over time, a flowrate marker (decane) was introduced into each sample, via a micropump controlled with the PolymerChar GPC-IR system. This flowrate marker (FM) was used to linearly correct the pump flowrate (Flowrate(nominal)) for each sample, by RV alignment of the respective decane peak within the sample (RV(FM Sample)), to that of the decane peak within the narrow standards calibration (RV(FM Calibrated)). Any changes in the time of the decane marker peak were then assumed to be related to a linear-shift in flowrate (Flowrate(effective)) for the entire run. To facilitate the highest accuracy of a RV measurement of the flow marker peak, a least-squares fitting routine was used to fit the peak of the flow marker concentration chromatogram to a quadratic equation. The first derivative of the quadratic equation was then used to solve for the true peak position. After calibrating the system, based on a flow marker peak, the effective flowrate (with respect to the narrow standards calibration) was calculated as Equation 7: Flowrate(effective)=Flowrate(nominal)*(RV(FM Calibrated)/RV(FM Sample)) (EQ7). Processing of the flow marker peak was done via the PolymerChar GPCOne™ Software. Acceptable flowrate correction is such that the effective flowrate should be within +/−0.7% of the nominal flowrate.

### Melt Index

The melt index I2 (or MI) of an ethylene-based polymer is measured in accordance with ASTM D-1238, condition 190° C./2.16 kg (melt index I10 at 190° C./10.0 kg). The I10/I2 was calculated from the ratio of I10 to the I2. The melt flow rate MFR of a propylene-based polymer is measured in accordance with ASTM D-1238, condition 230° C./2.16 kg.

### Density

ASTM D4703 was used to make a polymer plaque for density analysis. ASTM D792, Method B, was used to measure the density of each polymer.

### NMR (13C and 1H) Characterization of Terpolymers

For 13C NMR experiments, samples were dissolved, in 10 mm, NMR tubes, in tetrachloroethane-d2 (with or without 0.025 M Cr(acac)3). The concentration was approximately “300 mg/2.8 mL.” Each tube was then heated in a heating block set at 110° C. The sample tube was repeatedly vortexed and heated to achieve a homogeneous flowing fluid. The 13C NMR spectrum was taken on a BRUKER AVANCE 600 MHz spectrometer, equipped with a “10 mm C/H DUAL cryoprobe.” The following acquisition parameters were used: 60 seconds relaxation delay, 90 degree pulse of 12.0 μs, 256 scans. The spectrum was centered at 100 ppm, with a spectral width of 250 ppm. All measurements were taken without sample spinning at 110° C. The 13C NMR spectrum was referenced to “74.5 ppm” for the resonance peak of the solvent. For a sample with Cr, the data was taken with a “7 seconds relaxation delay” and 1024 scans. The “mol % silane (silane monomer)” was calculated based on the integration of SiMe carbon resonances, versus the integration of CH2 carbons associated with ethylene units and CH/CH3 carbons associated with octene units. The “mol % octene (or other alpha-olefin)” was similarly calculated with reference to the CH/CH3 carbons associated with octene (or other alpha-olefin).

For 1H NMR experiments, each sample was dissolved, in 8 mm, NMR tubes, in tetrachloroethane-d2 (with or without 0.001 M Cr(acac)3). The concentration was approximately “100 mg/1.8 mL.” Each tube was then heated in a heating block set at 110° C. The sample tube was repeatedly vortexed and heated to achieve a homogeneous flowing fluid. The 1H NMR spectrum was taken on a BRUKER AVANCE 600 MHz spectrometer, equipped with a “10 mm C/H DUAL cryoprobe.” A standard, single pulse 1H NMR experiment was performed. The following acquisition parameters were used: 70 seconds relaxation delay, 90 degree pulse of 17.2 μs, 32 scans. The spectrum was centered at 1.3 ppm, with a spectral width of 20 ppm. All measurements were taken, without sample spinning, at 110° C. The 1H NMR spectrum was referenced to “5.99 ppm” for the resonance peak of the solvent (residual protonated tetrachloroethane). For a sample with Cr, the data was taken with a “16 seconds relaxation delay” and 128 scans. The “mol % silane (silane monomer)” was calculated based on the integration of SiMe proton resonances, versus the integration of CH2 protons associated with ethylene units and CH3 protons associated with octene units.

### Differential Scanning Calorimetry (DSC)

Differential Scanning Calorimetry (DSC) is used to measure Tm, Tc, Tg and crystallinity in ethylene-based (PE) polymer samples and propylene-based (PP) polymer samples. Each sample (0.5 g) was compression molded into a film, at 5000 psi, 190° C., for two minutes. About 5 to 8 mg of film sample was weighed and placed in a DSC pan. The lid was crimped on the pan to ensure a closed atmosphere. Unless otherwise stated, the sample pan was placed in a DSC cell, and then heated, at a rate of 10° C./min, to a temperature of 180° C. for PE (230° C. for PP). The sample was kept at this temperature for three minutes. Then the sample was cooled at a rate of 10° C./min to −90° C. for PE (−60° C. for PP), and kept isothermally at that temperature for three minutes. The sample was next heated at a rate of 10° C./min, until complete melting (second heat). Unless otherwise stated, melting point (Tm) and the glass transition temperature (Tg) of each polymer were determined from the second heat curve, and the crystallization temperature (Tc) was determined from the first cooling curve. The respective peak temperatures for the Tm and the Tc are typically recorded. The percent crystallinity can be calculated by dividing the heat of fusion (Hf), determined from the second heat curve, by a theoretical heat of fusion of 292 J/g for PE (165 J/g for PP), and multiplying this quantity by 100 (for example, % cryst.=(Hf/292 J/g)×100 (for PE)).

### Experimental

### Materials

Polymers and additives are listed in Table 1 below.

TABLE 1
Polymers and Additives

| Component | Supplier | Descriptions |
|---|---|---|
| SiH-POE E | Dow | Ethylene/octene/silane terpolymer, |
| | | density = 0.870 g/cc, I2 = |
| | | 0.8 g/10 min, 3.4 wt % of HDMS |
| SiH-POE D | Dow | Ethylene/octene/silane terpolymer, |
| | | density = 0.873 g/cc, I2 = |
| | | 0.8 g/10 min, 1.5 wt % of HDMS |
| ENGAGE 8100 | Dow | Ethylene/octene copolymer, |
| | | density = 0.870 g/cc, I2 = |
| | | 1.0 g/10 min |
| DCP | SCRC | Crystal |
| AC9000 | SCRC | Powder |
| (Azodicarbonamide) | | |
| ZnO | SCRC | Powder |
| Steric acid | SCRC | Powder |
| Zinc stearate | SCRC | Powder |
| TALC 1250 | Haicheng | Powder, 1250 mesh |
| | Shuiquan | |
| | Co. Ltd. | |

### Polymer Syntheses and Properties

The interpolymers SiH-POE D and SiH-POE E were each prepared in a one gallon, polymerization reactor that was hydraulically full, and operated at steady state conditions. The solvent was ISOPAR-E, supplied by the ExxonMobil Chemical Company. The 5-hexenyldimethylsilane (HDMS) supplied by Gelest, was used as a termonomer, and was purified over AZ-300 alumina supplied by UOP Honeywell, prior to use. HDMS was fed to the reactor as a 22 wt % solution in ISOPAR-E. The reactor temperature was measured at or near the exit of the reactor. The interpolymer was isolated and pelletized. Polymerization conditions are listed in Table 2B-2D, and catalyst and co-catalysts are listed in Table 2A. The polymer properties are shown in Tables 3A and 3B.

TABLE 2A
Catalysts and Co-catalysts

| Catalyst (CAT) | Description |
|---|---|
| PE CAT 2 (WO2012/027448) | 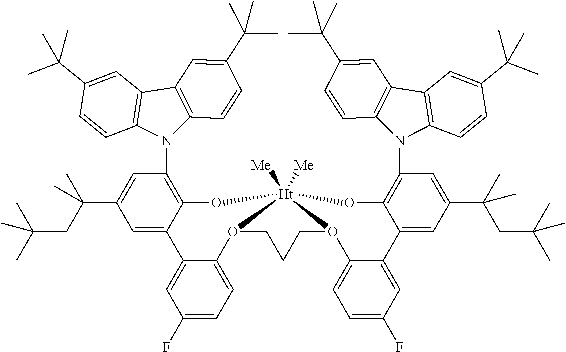 |
| Cocatalyst | |
| CoCAT-1 | A mixture of methyldi(C14-18 alkyl)ammonium salts of |
| | tetrakis(pentafluorophenyl)-borate, prepared by reaction of a long chain |
| | trialkylamine (Armeen ™ M2HT, available from Akzo-Nobel, Inc.), HCl and |
| | Li[B(C6F5)4], substantially as disclosed in USP 5,919,983, Ex. 2 (no further |
| | purification performed) (Boulder Scientific). |
| CoCAT-2 | Modified methylalumoxane (MMAO) Type 3A (no further purification |
| | performed) (Akzo Nobel). |

TABLE 2B
Polymerization Conditions to Produce Noted SiH-POEs and POE-D

| | Reactor | Reactor | | | | | | ethylene |
|---|---|---|---|---|---|---|---|---|
| | Temp., | Pressure, | Solvent, | Ethylene, | Octene, | HDMS, | Hydrogen, | conversion, |
| | ° C. | psig | lb/hr | lb/hr | lb/hr | lb/h | sccm | % |
| SiH- | 170 | 729 | 38 | 3.8 | 5.0 | 1.4 | 192 | 83 |
| POE D | | | | | | | | |
| SiH- | 168 | 726 | 36 | 3.8 | 5.0 | 2.9 | 193 | 82 |
| POE E | | | | | | | | |

TABLE 2C
Catalyst Feed Flows and Efficiency

| | | Catalyst | Catalyst | Overall Catalyst |
|---|---|---|---|---|
| | | Solution | Solution | Efficiency, (g |
| | | Flow, | Metal Conc., | interpolymer/g |
| | Catalyst | lb/hr | ppm* | total catalyst metal) |
| SiH-POE D | PE CAT 2 | 0.33 | 3.96 | 3,911,000 |
| SiH-POE E | PE CAT 2 | 0.57 | 3.96 | 2,385,000 |

*The “ppm” amount based on the weight of the respective catalyst feed solution.

TABLE 2D
Cocatalyst Feed Flows

| | CoCAT 1 | CoCAT 1 | CoCAT 2 | CoCAT 2 |
|---|---|---|---|---|
| | Solution | Solution | Solution | Solution |
| | Flow, | Conc., | Flow, | Conc. |
| | lb/hr | ppm* | lb/hr | ppm Al** |
| SiH-POE D | 0.34 | 31.25 | 0.30 | 32.2 |
| SiH-POE E | 0.58 | 31.25 | 0.53 | 32.2 |

*The “ppm” amount based on the weight of the co-catalyst feed solution.
**The “ppm” amount of Al based on the weight of the co-catalyst feed solution.

TABLE 3A
Polymer Properties

| Resin Description | | | | | Silane Information | | |
|---|---|---|---|---|---|---|---|
| | Density | MI | Octene | Tₘ | Silane | Silane | Silane |
| Resin | (g/cc) | (dg/min) | (mol %) | (C. °) | Type | mol %* | wt %** |
| SiH- | 0.873 | 0.8 | 11.0 | 64.5 | HDMS | 0.4 | 1.5 |
| POE D | | | | | | | |
| SiH- | 0.870 | 0.8 | 11.0 | 61.9 | HDMS | 0.9 | 3.4 |
| POE E | | | | | | | |

*Mol % silane based on total moles of monomers in polymer, and determined by 1H NMR.
**Wt % silane calculated from the mol %, and based on the weight of the interpolymer.
F: HDMS = 5-Hexenyldimethylsilane.

TABLE 3B
Polymer Properties (Conventional GPC)

| Resin | Mn (kg/mol) | Mw (kg/mol) | Mw/Mn |
|---|---|---|---|
| SiH-POE D | 49 | 108 | 2.2 |
| SiH-POE E | 45 | 100 | 2.2 |

### Study 1—Foam—Crosslinked, Foam Compositions—APRR and Mechanical Properties

First compositions for this study are listed in Table 4.

TABLE 4
First Compositions

| | IE-1 | CE-1 | IE-2 | CE-2 | CE-3 | CE-4 |
|---|---|---|---|---|---|---|
| SiH-POE E | 100 | | 100 | | | |
| ENGAGE 8100 | | 100 | | 100 | 100 | 100 |
| ZnO | 1 | 1 | 1 | 1 | 1 | 1 |
| ZnSt | 0.5 | 0.5 | 0.5 | 0.5 | 0.5 | 0.5 |
| HOSt | 0.5 | 0.5 | 0.5 | 0.5 | 0.5 | 0.5 |
| AC9000 | 2.5 | 2.5 | 3 | 3 | 2.5 | 3 |
| TALC1250 | 5 | 5 | 5 | 5 | 5 | 5 |
| DCP (pure) | 0.4 | 0.8 | 0.4 | 0.8 | 0.51 | 0.51 |
| Total Weight | 109.9 | 110.3 | 110.4 | 110.8 | 110.01 | 110.51 |

### Preparation of First Composition

The polymer (SiH-POE E or ENGAGE 8100) was added to the “1.5 liter” Banbury mixer, equilibrated at a temperature around 80° C.-100° C. (ambient atmosphere). After the polymer had melted (around 5 minutes), the zinc oxide, the zinc stearate, the steric acid and the talc were added. The blowing agent (AS9000) and the peroxide (DCP) were added last, and the composition was mixed for another 3 to 5 minutes, for a total mix time of 15 minutes, to form a gummy first composition (pre-crosslinking and pre-foaming).

### Preparation of Foam Sample (Bun Foam—Crosslinked and Foamed Composition)

The gummy first composition was transferred to a roll mill (Collin) equilibrated around 70° C. (ambient atm.), to form a blanked (approx. 5 mm thick). The blanket was cut into squares (approx. dimensions: 100 mm×100 mm×5 mm), and each square was placed into a bun foam mold (7 in×7 in×0.5 in), equilibrated at 130° C. (to mold the shape—no significant chemical reactions at this temperature). The sample was thermally treated inside the mold for 9 minutes, and then pressed at 10 tons for 4 minutes. The sample was then transferred between two plates of a blowing press (NC-S-420, Feng Cheih Precision Machinery Corp.), each plate equilibrated at 180° C., and held for 10 minutes under a pressure of 100 kg/cm², to form a bun foam (composition temperature 180° C.±10° C.). Once the pressure was released, the bun foam was removed quickly from the blowing press and placed in a vent hood on several non-stick sheets. The bun foam was allowed to cool overnight, and then cut into slices for testing.

### Foam Cutting and Slicing

Each bun foam was first cut into small foam plaques (6 in×6 in) using a vertical band saw. Foam density, foam hardness, foam shrinkage and foam rebound were measured on the small foam plaques (skin layers).

Thin slices (thickness of around 3 mm) were cut from the plaques using a lab scale horizontal band saw. These thinner slices (skin layers) were used to measure the tensile and tear properties.

### Durometer Hardness

The hardness was an average of five readings measured across the surface of the sample. The Asker C method was used in accordance with ASTM D2240.

### Foam Density

Each bun foam was cut into a “55 mm×50 mm (length×width)” block. The thickness depended on the expansion ratio of foam. This cube were then weighed on balance. Density of the foam was calculated as follows:

$$Density = \frac{Mass of the cube}{leng t h \times w i d t h \times t h i c k n e s s}$$

### Oven Shrinkage

Foam samples were cut using the vertical band saw, and the width (WI) and length (LI) were measured. The foam sample was placed in a pre-heated, air circulating oven, equilibrated at 70° C., and removed after 40 minutes. The width (WF) and the length (LF) were re-measured after cooling for 30 minutes at room temperature. The formula used to calculate the shrinkage of foam sample is Δ={1−[(WF+LF)/(WI+LI)]}*100.

### Falling Ball Rebound

A steel ball of ⅝″ diameter was dropped from a height of 500 mm onto the bun foam sample to determine the %-Rebound or Resilience. The %-Rebound=[(rebound height (mm)/500 mm)*100]. Rebound height was measured via a ruler.

### Tensile

Bun foam layers, each with thickness of approximately 3 mm were analyzed in accordance with ASTM D638 mechanical property characterization (Tensile), at a strain rate of 500 mm/minute.

### Compression Set

Compression Set (C-Set) was measured per ASTM D395 method B, under conditions of 50% compression at 50° C. for 6 hours. For each composition, two buttons, each with a diameter of 26 mm and thickness of 10 mm±0.5 mm, were cut from a bun foam. Each button was tested, and the average value was reported.

### Tear

Type C Tear was determined in accordance with ASTM D624. The split tear strength was measured by using a specimen with the dimension of 6 in. (length)×1 in. (width)×0.4 in. (thickness) and the notch depth of 1˜1.5 in., at the testing speed of 2 inches/minute.

### Gel Fraction (Gel %)

The gel fraction was determined by a hot xylene extraction method. Approximately 0.1 g of the crosslinked, foamed polymer composition (taken from a bunfoam) was weighed, and designated as a specimen weight W1. The weighed sample was placed in a 150 mL round-bottom flask, and 100 mL of xylene was placed in the round-bottom flask, and refluxed under heating, with a mantle heater, for 6 hours. Thereafter, the residue remaining after dissolution in the round-bottom flask was separated by filtering with a 100-mesh metal mesh, and the separated product was dried in a vacuum dryer at 80° C., for 8 hours or more. The weight of the resulting dried product (W2) was measured. The Gel %=[(W2/W1)×100].

### Acetophenone Concentration

A portion of the bun foam (approx. 2.8 g) was cut and sealed inside an aluminum bag. The foam was transferred to sealed vial, and the vial was heated via a headspace GC. The acetophenone evaporated out of the bottle, and was quantified by the headspace GC. The GC conditions are shown in Tables 5 and 6.

TABLE 5
Head Space GC
Agilent 7697A Headspace Sampler

| Headspace Oven Temperature | 150° | C. |
|---|---|---|
| Headspace Loop Temperature | 170° | C. |
| Transfer line Temperature | 190° | C. |
| Vial Equilibration Time | 30 | min |
| Injection Duration | 0.5 | min |
| GC Cycle Time | 35 | min |
| Vial Pressurization Gas | Helium | |
| Vial Pressurization Time | 0.50 | min |
| Oven Stabilization Time | 1.00 | min |
| Fill Pressure | 15.00 | psi |
| Extraction Mode | Single Extraction | |
| Loop Size | 1.00 | mL |

TABLE 6
Head Space GC

| | |
|---|---|
| Instrument | Agilent 7890A Gas Chromatography System |
| Column | DB-5 ms: 30 m × 250 μm × 0.25 μm |
| Carrier Flow | 1 ml/min; constant flow |
| | Helium carrier gas |
| Inlet | Split Ratio: 20:1, temperature: 280° C. |
| MSD | Acquisition Mode: Scan |
| | Scan Parameters: 29 amu-350 amu |
| | MS Source: 230° C. |
| | MS Quad: 150° C. |
| Solvent Delay | 0 min |

Hereby, the acetophenone residual ratio is denoted as “APRR” as shown below:

$$A P R R = \frac{Acetophenone concentration}{DCP loading in formulation} \times 100 \%$$

For example, for IE-1, the acetophenone concentration was 196.19 ppm (tested data) and DCP loading in formulation was 0.4/109.9=0.00364, i.e., 3640 ppm. Thus, the APRR of IE-1 is determined as follow:

$$A P R R = \frac{Acetophenone concentration}{DCP loading in formulation} \times 100 \% = \frac{196.19}{3640} \times 100 \% = 5.39 \% .$$

The APRR can be used to indicate the amount of acetophenone (AP) quenched by a composition.

The APRR results are shown in Table 7. ENGAGE 8100 was selected as the comparison resin due to the comparable density, melt index, and comonomers, to that of SiH-POE E. To compare the foam performance, the amounts of the blowing package (AC9000) and the additive package (ZnO, ZnSt, HOSt, and TALC 1250), in IE-1 and CE-1, were kept as the same (Table 7). Experimental results indicated the peroxide loading of CE-1 needs to be doubled, as compared with IE-1 (0.8 vs 0.4), to meet the comparable performance properties, such as hardness, tensile, split tear, rebound, and compression set. As seen in Table 7, for IE-1, only approximately 5% of acetophenone was detected, as compared to approximately 11% for CE-1. Another comparison group with a higher expansion ratio (for example, IE-2 and CE-2) further resulted in a similar observation (approx. 5% APRR (IE-2) versus approx. 9% (CE-2)), if the other performance properties were kept at the same level. Further reducing the DCP loading from 0.8 phr to 0.51 phr in ENGAGE 8100 (CE-3 and CE-4) sacrificed the properties, like tensile strength or compression set, but did not improve the APRR value (no decrease in APRR was observed).

TABLE 7
Compositions and Properties

| | IE-1 | CE-1 | IE-2 | CE-2 | CE-3 | CE-4 |
|---|---|---|---|---|---|---|
| SiH-POE E | 100 | | 100 | | | |
| ENGAGE | | 100 | | 100 | 100 | 100 |
| 8100 | | | | | | |
| ZnO | 1 | 1 | 1 | 1 | 1 | 1 |
| ZnSt | 0.5 | 0.5 | 0.5 | 0.5 | 0.5 | 0.5 |
| HOSt | 0.5 | 0.5 | 0.5 | 0.5 | 0.5 | 0.5 |
| AC9000 | 2.5 | 2.5 | 3 | 3 | 2.5 | 3 |
| TALC1250 | 5 | 5 | 5 | 5 | 5 | 5 |
| DCP (pure) | 0.4 | 0.8 | 0.4 | 0.8 | 0.51 | 0.51 |
| Total | 109.9 | 110.3 | 110.4 | 110.8 | 110.01 | 110.51 |
| Expansion | 168% | 167% | 179% | 179% | 180% | 183% |
| ratio | | | | | | |
| Gel % (wt %) | 78.5 | 79.4 | 82.4 | 77.3 | 54.1 | 44.4 |
| Density (g/cc) | 0.164 | 0.169 | 0.131 | 0.132 | 0.140 | 0.125 |
| Hardness C | 29.4 | 32.8 | 23 | 21.8 | 20.4 | 18.8 |
| Tensile | 2.41 | 2.27 | 1.99 | 1.96 | 1.82 | 1.68 |
| Strength | | | | | | |
| (MPa) | | | | | | |
| % Elongation | 421 | 352 | 394 | 363 | 445 | 469 |
| (%) | | | | | | |
| 100% Modulus | 0.65 | 0.72 | 0.54 | 0.55 | 0.43 | 0.36 |
| (MPa) | | | | | | |
| %-Rebound | 70 | 71 | 71 | 72 | 74 | 72 |
| Compression | 72.7% | 61.0% | 70.7% | 68.1% | 78.8% | 84.5% |
| set | | | | | | |
| (50° C., 6 h, | | | | | | |
| 30 min) | | | | | | |
| Split tear | 3.09 | 2.71 | 2.67 | 1.94 | 2.17 | 1.48 |
| (kg/cm) | | | | | | |
| Shrinkage | 6.2% | 9.2% | 9.6% | 8.2% | 10.4% | 7.5% |
| Linear, | | | | | | |
| 70° C./ | | | | | | |
| 40 min (%) | | | | | | |
| Acetophenone | 196.19 | 806.83 | 197.76 | 648.34 | 412.65 | 516.05 |
| (ppm) | | | | | | |
| APRR* | 5.39% | 11.12% | 5.46% | 8.98% | 8.90% | 11.18% |

*APRR = Acetophenone concentration/DCP concentration * 100%.

### Odor Ranking

A human panel of three participants was used to rank the odor of the inventive (IE-1 and IE-2) and comparative (CE-1-CE-4) foams. Each participant ranked the intensity of the odor of one bun foam per composition, according to the following ranking scale: Rank 0 (no odor), Rank+ (low odor (similar to an incumbent BIPB cued foam)), Rank++ (medium odor (intensity somewhere between the incumbent BIPB cured foam and an incumbent DCP cured foam)), Rank+++ (high odor (like the incumbent DCP cured foam)). Results are shown in Table 8, and indicate that IE-1 and IE-2 had significantly reduced odor versus the incumbent DCP cured foams.

TABLE 8
Odor Ranking

| | IE-1 | CE-1 | IE-2 | CE-2 | CE-3 | CE-4 |
|---|---|---|---|---|---|---|
| Odor | + | +++ | + | +++ | +++ | +++ |

Thus, inventive compositions have been developed that significantly reduce the odor associated with a “DCP curing package,” yet provide excellent properties in the final foam product, such as foam density, tensile strength, modulus, elongation, rebound, compression set, tear and shrinkage.

### Study 2—Foam—Crosslinked, Foam Compositions—Gel Content and Mechanical Properties

Foam compositions, gel content and mechanical properties are shown in Table 9. Each composition and each bun foam were prepared as respectively described above for Study 1. Each bun foam was cut as described for Study 1. Each foam (skin layer) was characterized by gel content, density, hardness, tensile, elongation, modulus, rebound and compression set, according to the respective test methods described above for Study 1.

TABLE 9
Compositions and Characterizations

| | IE-1 | CE-1 | IE-2 | CE-2 | CE-3 | CE-4 | CE-5 | CE-6 | IE-3 |
|---|---|---|---|---|---|---|---|---|---|
| SIH-POE E | 100 | | 100 | | | | 100 | 100 | |
| SiH-POE D | | | | | | | | | 100 |
| ENGAGE 8100 | | 100 | | 100 | 100 | 100 | | | |
| ZnO | 1 | 1 | 1 | 1 | 1 | 1 | 1 | 1 | 1 |
| ZnSt | 0.5 | 0.5 | 0.5 | 0.5 | 0.5 | 0.5 | 0.5 | 0.5 | 0.5 |
| HOSt | 0.5 | 0.5 | 0.5 | 0.5 | 0.5 | 0.5 | 0.5 | 0.5 | 0.5 |
| AC9000 | 2.5 | 2.5 | 3 | 3 | 2.5 | 3 | 2.5 | 2.5 | 2.5 |
| Talc1250 | 5 | 5 | 5 | 5 | 5 | 5 | 5 | 5 | 5 |
| DCP (pure) | 0.4 | 0.8 | 0.4 | 0.8 | 0.51 | 0.51 | 0.1 | 1 | 0.3 |
| Total | 109.9 | 110.3 | 110.4 | 110.8 | 110.01 | 110.51 | 109.6 | 110.5 | 109.8 |
| Gel % (wt %) | 78.5% | 79.4% | 82.4% | 77.3% | 54.1% | 44.4% | 0.2% | 95.1% | 80.1% |

| | | | | | | | | |
|---|---|---|---|---|---|---|---|---|
| Density (g/cc) | 0.164 | 0.169 | 0.131 | 0.132 | 0.140 | 0.125 | Failed to | 0.139 |
| Hardness C | 29.4 | 32.8 | 23 | 21.8 | 20.4 | 18.8 | make a foam. | 25.4 |
| Tensile Strength (MPa) | 2.41 | 2.27 | 1.99 | 1.96 | 1.82 | 1.68 | No | 2.05 |
| % Elongation (%) | 421 | 352 | 394 | 363 | 445 | 469 | performance | 426 |
| 100% Modulus (MPa) | 0.65 | 0.72 | 0.54 | 0.55 | 0.43 | 0.36 | testing results. | 0.52 |
| %-Rebound | 70 | 71 | 71 | 72 | 74 | 72 | | 68 |
| C-set (50° C., 6 h, 30 min) | 72.7% | 61.0% | 70.7% | 68.1% | 78.8% | 84.5% | | 80.7% |

As seen in Table 9, each inventive composition provided a crosslinked foam with a better of crosslinking density (here, gel content 78%-82%) and excellent mechanical properties, such as tensile, modulus and elongation. It is noted that composition CE-5 hada very low Gel % (0.2 wt %) and composition CE-6 hada very high Gel % (95.1 wt %). Both compositions were unsuitable for foam formation.

1. A process to form a crosslinked, foamed composition, the process comprising thermally treating a first composition that comprises the following components:
a) at least one olefin/silane interpolymer comprising at least one Si—H group,
b) at least one peroxide, and
c) at least one blowing agent.

2. The process of claim 1, wherein the crosslinked, foam composition (C) has a reduced acetophenone residual ratio (APRR), as compared to a similar composition (SC) that comprises the same components, except that the olefin/silane interpolymer of component a is replaced with a similar olefin-based polymer that contains the same monomer types as the interpolymer of component a, except the olefin-based polymer does not contain the “at least one Si—H group,” and wherein the similar olefin-based polymer has a density that is within ±0.005 g/cc of the density of component a, and has a melt index (I2) that is within ±0.5 g/10 min of the melt index of component a; and wherein the Reduction in APRR (%)={[(APRR for (SC))−(APRR for (C))]/(APRR for (SC))}×100.

3. The process of claim 1, wherein the crosslinked, foamed composition has an acetophenone residual ratio (APRR) ≤12%.

4. The process of claim 1, wherein the crosslinked, foamed composition has a gel content (Gel %) from 30 wt % to 85 wt %.

5. The process of claim 1, wherein component b is selected from Formula P: 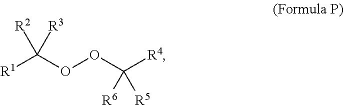
where R1 is a substituted or unsubstituted aryl group; R4 is a substituted or unsubstituted aryl group; R2, R3, R5 and R6 are each, independently, alkyl or H.

6. The process of claim 5, wherein Formula P is di-cumyl peroxide.

7. The process of claim 1, wherein the olefin/silane interpolymer of component a is an ethylene/alpha-olefin/silane interpolymer.

8. The process of claim 1, wherein the first composition is thermally treated at a temperature from 150° C. to 200° C.

9. A first composition comprising the following components:
a) at least one olefin/silane interpolymer comprising at least one Si—H group,
b) at least one peroxide, and
c) at least one blowing agent.

10. The first composition of claim 9, wherein component b is selected from Formula P: 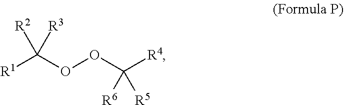
where R1 is a substituted or unsubstituted aryl group; R4 is a substituted or unsubstituted aryl group; R2, R3, R5 and R6 are each, independently, alkyl or H.

11. The first composition of claim 9, wherein Formula P is di-cumyl peroxide.

12. The first composition of claim 9, wherein the olefin/silane interpolymer of component a is an ethylene/alpha-olefin/silane interpolymer.

13. The first composition of claim 9, wherein the olefin/silane interpolymer of component a has a density from 0.855 g/cc to 0.940 g/cc.

14. The first composition of claim 9, wherein the olefin/silane interpolymer of component a has a melt index (I2) from 0.2 g/10 min to 100 g/10 min.

15. The first composition of claim 9, wherein the weight ratio of component a to component b is from 150 to 400.

16. A crosslinked, foamed composition formed from the first composition of claim 9.

17. The crosslinked, foamed composition of claim 16, wherein the crosslinked, foam composition (C) has a reduced acetophenone residual ratio (APRR), as compared to a similar composition (SC) that comprises the same components, except that the olefin/silane interpolymer of component a is replaced with a similar olefin-based polymer that contains the same monomer types as the interpolymer of component a, except the olefin-based polymer does not contain the “at least one Si—H group,” and wherein the similar olefin-based polymer has a density that is within ±0.005 g/cc of the density of component a, and has a melt index (I2) that is within ±0.5 g/10 min of the melt index of component a; and wherein the Reduction in APRR
$$( \% ) = \{ [ ( A P R R for ( SC ) ) - ( A P R R for ( C ) ) ] / ( A P R R for ( SC ) ) \} \times 10 \; 0 .$$

18. The crosslinked, foamed composition of claim 16, wherein the crosslinked, foamed composition has an acetophenone residual ratio (APRR) ≤12%.

19. The crosslinked, foamed composition of claim 16, wherein the crosslinked, foamed composition has a gel content (Gel %) from 30 wt % to 85 wt %.

20. An article comprising at least one component formed from the crosslinked, foamed composition of claim 16.
